(19) United States
(12) Patent Application Publication
(10) Pub. No.: US 2015/0143299 A1
(43) Pub. Date: May 21, 2015

(54) MOBILE TERMINAL AND CONTROLLING METHOD THEREOF

(71) Applicant: LG ELECTRONICS INC., Seoul (KR)

(72) Inventors: Koonsoon KIM, Seoul (KR); Sunghoon CHOI, Seoul (KR); Seongjin KIM, Seoul (KR); Kang LEE, Seoul (KR)

(73) Assignee: LG ELECTRONICS INC., Seoul (KR)

(21) Appl. No.: 14/546,969

(22) Filed: Nov. 18, 2014

(30) Foreign Application Priority Data
Nov. 19, 2013 (KR) 10-2013-0140571

(51) Int. Cl. G06F 3/0482; G06F 3/0488; H04M 1/725; G06F 3/0481

(52) U.S. Cl. CPC G06F 3/0482; G06F 3/04817; G06F 3/0488; H04M 1/72519
USPC 715/835

(57) ABSTRACT

The mobile terminal according to the present invention includes a display, and a controller configured to cause the display to display an object related to content, a menu icon for processing the content in response to a first touch input applied to the object, a submenu associated with the menu icon in response to a second touch input applied to the menu icon, and first information corresponding to the submenu at a location where the object or the menu icon was displayed in response to a third touch input applied to the submenu.

Pursuant to 35 U.S.C. §119(a), this application claims the benefit of earlier filing date and right of priority to Korean Application No. 10-2013-0140571, filed on Nov. 19, 2013, the contents of which are hereby incorporated by reference herein in its entirety.

### BACKGROUND OF THE INVENTION

1. Field of the Invention

The present invention relates to a mobile terminal, and more particularly, to a mobile terminal and controlling method thereof. Although the present invention is suitable for a wide scope of applications, it is particularly suitable for displaying information that suggests a content processing method.

2. Discussion of the Related Art

A mobile terminal is a device which may be configured to perform various functions. Examples of such functions include data and voice communications, capturing images and video via a camera, recording audio, playing music files and outputting music via a speaker system, and displaying images and video on a display.

Generally, terminals can be classified into mobile terminals and stationary terminals according to a presence or non-presence of mobility. And, the mobile terminals can be further classified into handheld terminals and vehicle mount terminals according to availability for hand-carry.

There are ongoing efforts to support and increase the functionality of mobile terminals. Such efforts include software and hardware improvements, as well as changes and improvements in the structural components which form the mobile terminal.

In order to enlarge the utilization of a mobile terminal, a multitude of developers make ongoing efforts to research and develop various applications runnable in the mobile terminal. As a result of the efforts, a multitude of applications may exist to perform the same function, which can provide a user with convenience in installing and utilizing an application suitable for user's preference. If a plurality of applications performing the same function are installed on a mobile terminal, a user may be able to run an application appropriate for a user's ever-changing preference. For instance, in case that a multitude of applications for watching a photo file are installed, a user can watch the photo file through a desired application in consideration of UI facilitation and utilization for each of the applications.

However, if a great number of applications are installed on a mobile terminal, it may be difficult for a user to search the applications for a desired application.

### SUMMARY OF THE INVENTION

Accordingly, embodiments of the present invention are directed to a mobile terminal and controlling method thereof that substantially obviate one or more problems due to limitations and disadvantages of the related art.

An object of the present invention is to provide a mobile terminal and controlling method thereof, by which user's convenience can be enhanced.

In particular, one object of the present invention is to provide a mobile terminal and controlling method thereof, by which a user can be guided to an application suitable for appreciating a specific content.

Another object of the present invention is to provide a mobile terminal and controlling method thereof, by which a user can be guided to an application to run.

Additional advantages, objects, and features of the invention will be set forth in the disclosure herein as well as the accompanying drawings. Such aspects may also be appreciated by those skilled in the art based on the disclosure herein.

To achieve these objects and other advantages and in accordance with the purpose of the invention, as embodied and broadly described herein, a mobile terminal according to one embodiment of the present invention may include a display, and a controller configured to cause the display to display an object related to content, a menu icon for processing the content in response to a first touch input applied to the object, a submenu associated with the menu icon in response to a second touch input applied to the menu icon, and first information corresponding to the submenu at a location where the object or the menu icon was displayed in response to a third touch input applied to the submenu.

In another aspect of the present invention, a mobile terminal according to another embodiment of the present invention may include a display, and a controller configured to cause the display to display an object related to content, at least one menu icon for processing the content in response to a first touch input applied to the object, and first information suggesting a scheme for processing the content at a location where the object or one of the at least one menu icon was displayed in response to a second touch input applied to the one of the at least one menu icon.

In further aspect of the present invention, a method of controlling a mobile terminal according to further embodiment of the present invention may include displaying an object related to content, displaying a menu icon for processing the content in response to a first touch input applied to the object, displaying a submenu associated with the menu icon in response to a second touch input applied to the menu icon, and displaying information corresponding to the submenu at a location where the object or the menu icon was displayed in response to a third touch input applied to the submenu.

Effects obtainable from the present invention may be non-limited by the above mentioned effect. And, other unmentioned effects can be clearly understood from the following description by those having ordinary skill in the technical field to which the present invention pertains.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. The above and other aspects, features, and advantages of the present invention will become more apparent upon consideration of the following description of preferred embodiments, taken in conjunction with the accompanying drawing figures. In the drawings:

FIG. 1 is a block diagram of a mobile terminal according to one embodiment of the present invention;

FIG. 2 is a front perspective diagram of a mobile terminal according to one embodiment of the present invention;

FIG. 3 is a rear perspective diagram of a mobile terminal according to one embodiment of the present invention;

FIG. 4 is a flowchart for an operation of a mobile terminal according to one embodiment of the present invention;

FIGS. 5A to 5I are diagrams for examples of displaying menu icons on a display unit;

FIGS. 6A and 6B are diagrams for one example of displaying activated menu icons and deactivated menu icons;

FIGS. 7A and 7B are diagrams for one example of displaying a selected menu icon visually and identifiably;

FIGS. 8A to 8H are diagrams for examples of displaying sub-menu icons subordinate to a selected menu icon;

FIGS. 9A to 9H are diagrams for examples of displaying suggestion information for suggesting a content processing method at a location where a menu icon was displayed;

FIGS. 10A to 10F are diagrams for examples of displaying a content processed information at a location where a menu icon was displayed;

FIGS. 11A to 11D are diagrams for one example of displaying suggestion information at a location, where a menu icon was displayed, if the menu icon is selected;

FIGS. 12A to 12G are diagrams for examples of displaying suggestion information for suggesting a content processing method at a location where a menu icon was displayed;

FIGS. 13A and 13B are diagrams to describe one example of an operation in case of receiving a touch input while a content is displayed;

FIG. 14 is a diagram for one example of displaying a menu icon while a photo is taken;

FIGS. 15A to 15C are diagrams for one example of displaying a menu icon by grouping a plurality of contents and targeting a grouped content;

FIG. 16 is a diagram for one example of displaying a menu icon by targeting a plurality of music files belonging to a single group;

FIGS. 17A and 17B are diagrams for one example of displaying a menu icon for processing a content attached to an email or message; and

FIGS. 18A to 18C are diagrams for one example of displaying a menu icon for an incomplete content.

### DETAILED DESCRIPTION OF THE INVENTION

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

As used herein, the suffixes ‘module’, ‘unit’ and ‘part’ are used for elements in order to facilitate the disclosure only. Therefore, significant meanings or roles are not given to the suffixes themselves and it is understood that the ‘module’, ‘unit’ and ‘part’ can be used together or interchangeably.

The present invention can be applicable to a various types of mobile terminals. Examples of such terminals include mobile phones, user equipments, smart phones, digital broadcast receivers, personal digital assistants, laptop computers, portable multimedia players (PMP), navigators and the like.

Yet, it is apparent to those skilled in the art that a configuration according to an embodiment disclosed in this specification is applicable to such a fixed terminal as a digital TV, a desktop computer and the like as well as a mobile terminal.

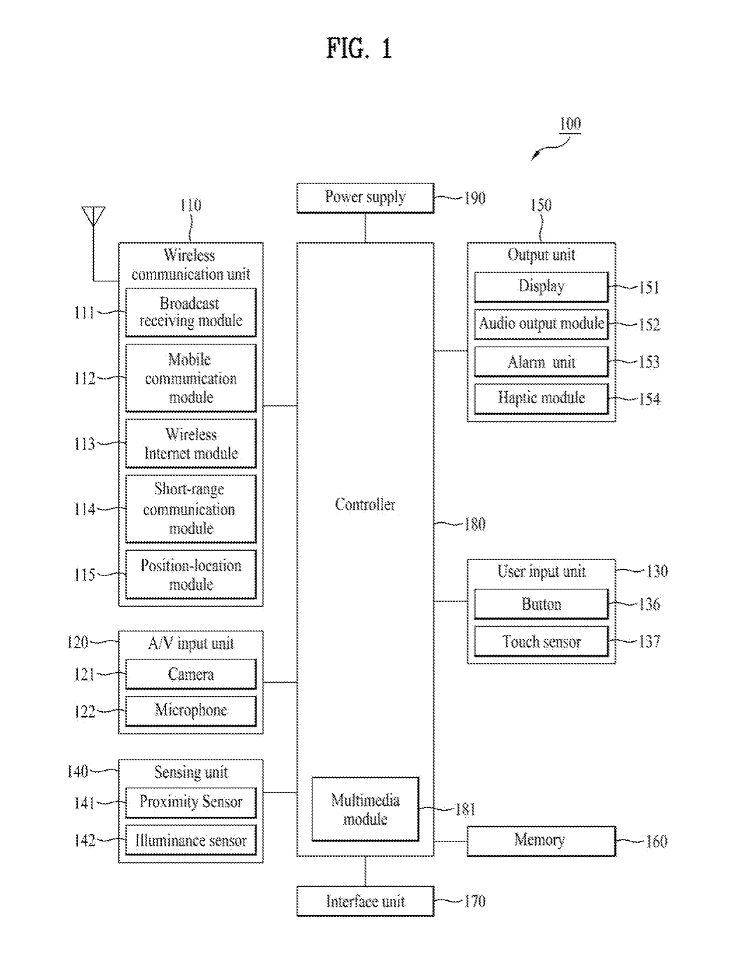

FIG. 1 is a block diagram of a mobile terminal 100 in accordance with an embodiment of the present invention. FIG. 1 shows the mobile terminal 100 according to one embodiment of the present invention includes a wireless communication unit 110, an A/V (audio/video) input unit 120, a user input unit 130, a sensing unit 140, an output unit 150, a memory 160, an interface unit 170, a controller 180, a power supply unit 190 and the like. FIG. 1 shows the mobile terminal 100 having various components, but it is understood that implementing all of the illustrated components is not a requirement. Greater or fewer components may alternatively be implemented.

In the following description, the above elements of the mobile terminal 100 are explained in sequence.

First of all, the wireless communication unit 110 typically includes one or more components which permits wireless communication between the mobile terminal 100 and a wireless communication system or network within which the mobile terminal 100 is located. For instance, the wireless communication unit 110 can include a broadcast receiving module 111, a mobile communication module 112, a wireless internet module 113, a short-range communication module 114, a position-location module 115 and the like.

The broadcast receiving module 111 receives a broadcast signal and/or broadcast associated information from an external broadcast managing server via a broadcast channel. The broadcast channel may include a satellite channel and a terrestrial channel. At least two broadcast receiving modules 111 can be provided to the mobile terminal 100 in pursuit of simultaneous receptions of at least two broadcast channels or broadcast channel switching facilitation.

The broadcast managing server generally refers to a server which generates and transmits a broadcast signal and/or broadcast associated information or a server which is provided with a previously generated broadcast signal and/or broadcast associated information and then transmits the provided signal or information to a terminal. The broadcast signal may be implemented as a TV broadcast signal, a radio broadcast signal, and a data broadcast signal, among others. If desired, the broadcast signal may further include a broadcast signal combined with a TV or radio broadcast signal.

The broadcast associated information includes information associated with a broadcast channel, a broadcast program, a broadcast service provider, etc. And, the broadcast associated information can be provided via a mobile communication network. In this case, the broadcast associated information can be received by the mobile communication module 112.

The broadcast associated information can be implemented in various forms. For instance, broadcast associated information may include an electronic program guide (EPG) of digital multimedia broadcasting (DMB) and electronic service guide (ESG) of digital video broadcast-handheld (DVB-H).

The broadcast receiving module 111 may be configured to receive broadcast signals transmitted from various types of broadcast systems. By nonlimiting example, such broadcasting systems include digital multimedia broadcasting-terrestrial (DMB-T), digital multimedia broadcasting-satellite (DMB-S), digital video broadcast-handheld (DVB-H), Convergence of Broadcasting and Mobile Service (DVB-CBMS), Open Mobile Alliance-BroadCAST (OMA-BCAST), China Multimedia Mobile Broadcasting (CMMB), Mobile Broadcasting Business Management System (MBBMS), the data broadcasting system known as media forward link only (MediaFLO®) and integrated services digital broadcast-terrestrial (ISDB-T). Optionally, the broadcast receiving module 111 can be configured suitable for other broadcasting systems as well as the above-explained digital broadcasting systems.

The broadcast signal and/or broadcast associated information received by the broadcast receiving module 111 may be stored in a suitable device, such as a memory 160.

The mobile communication module 112 transmits/receives wireless signals to/from one or more network entities (e.g., base station, external terminal, server, etc.) via a mobile network such as GSM (Global System for Mobile communications), CDMA (Code Division Multiple Access), WCDMA (Wideband CDMA) and so on. Such wireless signals may represent audio, video, and data according to text/multimedia message transceivings, among others.

The wireless internet module 113 supports Internet access for the mobile terminal 100. This module may be internally or externally coupled to the mobile terminal 100. In this case, the wireless Internet technology can include WLAN (Wireless LAN) (Wi-Fi), Wibro (Wireless broadband), Wimax (World Interoperability for Microwave Access), HSDPA (High Speed Downlink Packet Access), GSM, CDMA, WCDMA, LTE (Long Term Evolution) etc.

Wireless internet access by Wibro, HSPDA, GSM, CDMA, WCDMA, LTE or the like is achieved via a mobile communication network. In this aspect, the wireless internet module 113 configured to perform the wireless internet access via the mobile communication network can be understood as a sort of the mobile communication module 112.

The short-range communication module 114 facilitates relatively short-range communications. Suitable technologies for implementing this module include radio frequency identification (RFID), infrared data association (IrDA), ultra-wideband (UWB), as well at the networking technologies commonly referred to as Bluetooth and ZigBee, to name a few.

The position-location module 115 identifies or otherwise obtains the location of the mobile terminal 100. If desired, this module may be implemented with a global positioning system (GPS) module. According to the current technology, the GPS module 115 is able to precisely calculate current 3-dimensional position information based on at least one of longitude, latitude and altitude and direction (or orientation) by calculating distance information and precise time information from at least three satellites and then applying triangulation to the calculated information. Currently, location and time informations are calculated using three satellites, and errors of the calculated location position and time informations are then amended using another satellite. Besides, the GPS module 115 is able to calculate speed information by continuously calculating a real-time current location.

Referring to FIG. 1, the audio/video (A/V) input unit 120 is configured to provide audio or video signal input to the mobile terminal 100. As shown, the A/V input unit 120 includes a camera 121 and a microphone 122. The camera 121 receives and processes image frames of still pictures or video, which are obtained by an image sensor in a video call mode or a photographing mode. And, the processed image frames can be displayed on the display 151.

The image frames processed by the camera 121 can be stored in the memory 160 or can be externally transmitted via the wireless communication unit 110. Optionally, at least two cameras 121 can be provided to the mobile terminal 100 according to environment of usage.

The microphone 122 receives an external audio signal while the portable device is in a particular mode, such as phone call mode, recording mode and voice recognition. This audio signal is processed and converted into electric audio data. The processed audio data is transformed into a format transmittable to a mobile communication base station via the mobile communication module 112 in case of a call mode. The microphone 122 typically includes assorted noise removing algorithms to remove noise generated in the course of receiving the external audio signal.

The user input unit 130 generates input data responsive to user manipulation of an associated input device or devices. Examples of such devices include a button 136 provided to front/rear/lateral side of the mobile terminal 100 and a touch sensor (constant pressure/electrostatic) 137 and may further include a key pad, a dome switch, a jog wheel, a jog switch and the like [not shown in the drawing].

The sensing unit 140 provides sensing signals for controlling operations of the mobile terminal 100 using status measurements of various aspects of the mobile terminal. For instance, the sensing unit 140 may detect an open/close status of the mobile terminal 100, relative positioning of components (e.g., a display and keypad) of the mobile terminal 100, a change of position of the mobile terminal 100 or a component of the mobile terminal 100, a presence or absence of user contact with the mobile terminal 100, orientation or acceleration/deceleration of the mobile terminal 100. By nonlimiting example, such sensing unit 140 include, gyro sensor, accelerate sensor, geomagnetic sensor.

As an example, consider the mobile terminal 100 being configured as a slide-type mobile terminal. In this configuration, the sensing unit 140 may sense whether a sliding portion of the mobile terminal is open or closed. Other examples include the sensing unit 140 sensing the presence or absence of power provided by the power supply 190, the presence or absence of a coupling or other connection between the interface unit 170 and an external device. And, the sensing unit 140 can include a proximity sensor 141.

The output unit 150 generates outputs relevant to the senses of sight, hearing, touch and the like. And, the output unit 150 includes the display 151, an audio output module 152, an alarm unit 153, and a haptic module 154 and the like.

The display 151 is typically implemented to visually display (output) information associated with the mobile terminal 100. For instance, if the mobile terminal is operating in a phone call mode, the display will generally provide a user interface (UI) or graphical user interface (GUI) which includes information associated with placing, conducting, and terminating a phone call. As another example, if the mobile terminal 100 is in a video call mode or a photographing mode, the display 151 may additionally or alternatively display images which are associated with these modes, the UI or the GUI.

The display module 151 may be implemented using known display technologies including, for example, a liquid crystal display (LCD), a thin film transistor-liquid crystal display (TFT-LCD), an organic light-emitting diode display (OLED), a flexible display and a three-dimensional display. The mobile terminal 100 may include one or more of such displays.

Some of the above displays can be implemented in a transparent or optical transmittive type, which can be named a transparent display. As a representative example for the transparent display, there is TOLED (transparent OLED) or the like. A rear configuration of the display 151 can be implemented in the optical transmittive type as well. In this configuration, a user is able to see an object in rear of a terminal body via the area occupied by the display 151 of the terminal body.

At least two displays 151 can be provided to the mobile terminal 100 in accordance with the implemented configuration of the mobile terminal 100. For instance, a plurality of displays can be arranged on a single face of the mobile terminal 100 in a manner of being spaced apart from each other or being built in one body. Alternatively, a plurality of displays can be arranged on different faces of the mobile terminal 100.

In case that the display 151 and the touch sensor 137 configures a mutual layer structure (hereinafter called ‘touch screen’), it is able to use the display 151 as an input device as well as an output device. In this case, the touch sensor can be configured as a touch film, a touch sheet, a touchpad or the like.

The touch sensor 137 can be configured to convert a pressure applied to a specific portion of the display 151 or a variation of a capacitance generated from a specific portion of the display 151 to an electric input signal. Moreover, it is able to configure the touch sensor 137 to detect a pressure of a touch as well as a touched position or size.

If a touch input is made to the touch sensor 137, signal(s) corresponding to the touch is transferred to a touch controller. The touch controller processes the signal(s) and then transfers the processed signal(s) to the controller 180. Therefore, the controller 180 is able to know whether a prescribed portion of the display 151 is touched.

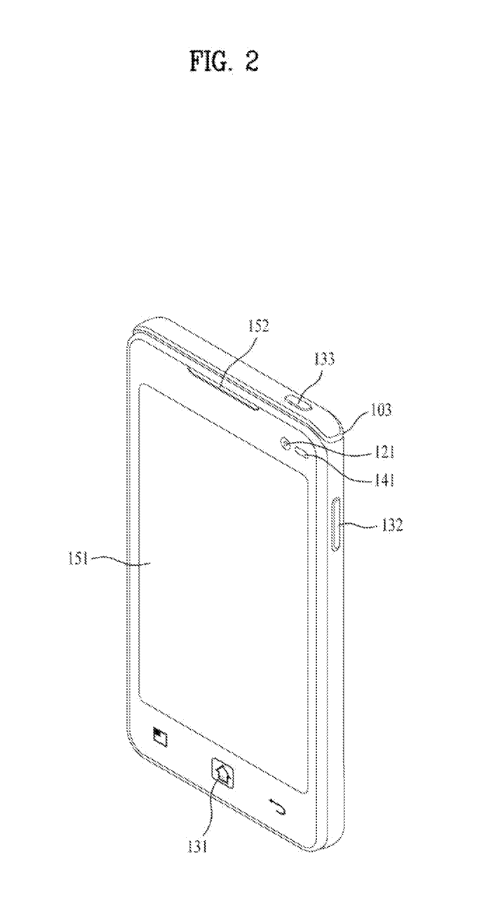

Referring to FIG. 2, a proximity sensor (141) can be provided to an internal area of the mobile terminal 100 enclosed by the touchscreen or around the touchscreen. The proximity sensor is the sensor that detects a presence or non-presence of an object approaching a prescribed detecting surface or an object existing around the proximity sensor using an electromagnetic field strength or infrared ray without mechanical contact. Hence, the proximity sensor has durability longer than that of a contact type sensor and also has utility wider than that of the contact type sensor.

The proximity sensor can include one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor and the like. In case that the touchscreen includes the electrostatic capacity proximity sensor, it is configured to detect the proximity of a pointer using a variation of electric field according to the proximity of the pointer. In this case, the touchscreen (touch sensor) can be classified as the proximity sensor.

For clarity and convenience of the following description, as a pointer becomes proximate to a touchscreen without coming into contact with the touchscreen, if the pointer is perceived as situated over the touchscreen, such an action shall be named ‘proximity touch’. If a pointer actually comes into contact with a touchscreen, such an action shall be named ‘contact touch’. A proximity-touched position over the touchscreen with the pointer may mean a position at which the pointer vertically opposes the touchscreen when the touchscreen is proximity-touched with the pointer.

The proximity sensor detects a proximity touch and a proximity touch pattern (e.g., a proximity touch distance, a proximity touch duration, a proximity touch position, a proximity touch shift state, etc.). And, information corresponding to the detected proximity touch action and the detected proximity touch pattern can be outputted to the touchscreen.

The audio output module 152 functions in various modes including a call-receiving mode, a call-placing mode, a recording mode, a voice recognition mode, a broadcast reception mode and the like to output audio data which is received from the wireless communication unit 110 or is stored in the memory 160. During operation, the audio output module 152 outputs audio relating to a particular function (e.g., call received, message received, etc.). The audio output module 152 is often implemented using one or more speakers, buzzers, other audio producing devices, and combinations thereof.

The alarm unit 153 is output a signal for announcing the occurrence of a particular event associated with the mobile terminal 100. Typical events include a call received event, a message received event and a touch input received event. The alarm unit 153 is able to output a signal for announcing the event occurrence by way of vibration as well as video or audio signal. The video or audio signal can be outputted via the display 151 or the audio output unit 152. Hence, the display 151 or the audio output module 152 can be regarded as a part of the alarm unit 153.

The haptic module 154 generates various tactile effects that can be sensed by a user. Vibration is a representative one of the tactile effects generated by the haptic module 154. Strength and pattern of the vibration generated by the haptic module 154 are controllable. For instance, different vibrations can be outputted in a manner of being synthesized together or can be outputted in sequence.

The haptic module 154 is able to generate various tactile effects as well as the vibration. For instance, the haptic module 154 generates the effect attributed to the arrangement of pins vertically moving against a contact skin surface, the effect attributed to the injection/suction power of air though an injection/suction hole, the effect attributed to the skim over a skin surface, the effect attributed to the contact with electrode, the effect attributed to the electrostatic force, the effect attributed to the representation of hold/cold sense using an endothermic or exothermic device and the like.

The haptic module 154 can be implemented to enable a user to sense the tactile effect through a muscle sense of finger, arm or the like as well as to transfer the tactile effect through a direct contact. Optionally, at least two haptic modules 154 can be provided to the mobile terminal 100 in accordance with the corresponding configuration type of the mobile terminal 100.

The memory unit 160 is generally used to store various types of data to support the processing, control, and storage requirements of the mobile terminal 100. Examples of such data include program instructions for applications operating on the mobile terminal 100, contact data, phonebook data, messages, audio, still pictures (or photo), moving pictures, etc. And, a recent use history or a cumulative use frequency of each data (e.g., use frequency for each phonebook, each message or each multimedia) can be stored in the memory unit 160. Moreover, data for various patterns of vibration and/or sound outputted in case of a touch input to the touchscreen can be stored in the memory unit 160.

The memory 160 may be implemented using any type or combination of suitable volatile and non-volatile memory or storage devices including hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory, card-type memory (e.g., SD memory, XD memory, etc.), or other similar memory or data storage device. And, the mobile terminal 100 is able to operate in association with a web storage for performing a storage function of the memory 160 on Internet.

The interface unit 170 is often implemented to couple the mobile terminal 100 with external devices. The interface unit 170 receives data from the external devices or is supplied with the power and then transfers the data or power to the respective elements of the mobile terminal 100 or enables data within the mobile terminal 100 to be transferred to the external devices. The interface unit 170 may be configured using a wired/wireless headset port, an external charger port, a wired/wireless data port, a memory card port, a port for coupling to a device having an identity module, audio input/output ports, video input/output ports, an earphone port and/or the like.

The identity module is the chip for storing various kinds of information for authenticating a use authority of the mobile terminal 100 and can include User Identify Module (UIM), Subscriber Identify Module (SIM), Universal Subscriber Identity Module (USIM) and/or the like. A device having the identity module (hereinafter called ‘identity device’) can be manufactured as a smart card. Therefore, the identity device is connectible to the mobile terminal 100 via the corresponding port.

When the mobile terminal 110 is connected to an external cradle, the interface unit 170 becomes a passage for supplying the mobile terminal 100 with a power from the cradle or a passage for delivering various command signals inputted from the cradle by a user to the mobile terminal 100. Each of the various command signals inputted from the cradle or the power can operate as a signal enabling the mobile terminal 100 to recognize that it is correctly loaded in the cradle.

The controller 180 typically controls the overall operations of the mobile terminal 100. For example, the controller 180 performs the control and processing associated with voice calls, data communications, video calls, etc. The controller 180 may include a multimedia module 181 that provides multimedia playback. The multimedia module 181 may be configured as part of the controller 180, or implemented as a separate component.

Moreover, the controller 180 is able to perform a pattern (or image) recognizing process for recognizing a writing input and a picture drawing input carried out on the touchscreen as characters or images, respectively.

The power supply unit 190 provides power required by the various components for the mobile terminal 100. The power may be internal power, external power, or combinations thereof.

A battery may include a built-in rechargeable battery and may be detachably attached to the terminal body for a charging and the like. A connecting port may be configured as one example of the interface 170 via which an external charger for supplying a power of a battery charging is electrically connected.

Various embodiments described herein may be implemented in a computer-readable medium using, for example, computer software, hardware, or some combination thereof.

For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. Such embodiments may also be implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory such as the memory 160, and executed by a controller or processor, such as the controller 180.

FIG. 2 is a front perspective diagram of a mobile terminal according to one embodiment of the present invention.

The mobile terminal 100 shown in the drawing has a bar type terminal body. Yet, the mobile terminal 100 may be implemented in a variety of different configurations. Examples of such configurations include folder-type, slide-type, rotational-type, swing-type and combinations thereof. For clarity, further disclosure will primarily relate to a bar-type mobile terminal 100. However such teachings apply equally to other types of mobile terminals.

Referring to FIG. 2A, the mobile terminal 100 includes a case (101, 102, 103) configuring an exterior thereof. In the present embodiment, the case can be divided into a front case 101 and a rear case 102. Various electric/electronic parts are loaded in a space provided between the front and rear cases 101 and 102.

Occasionally, electronic components can be mounted on a surface of the rear case 102. The electronic part mounted on the surface of the rear case 102 may include such a detachable part as a battery, a USIM card, a memory card and the like. In doing so, the rear case 102 may further include a backside cover 103 configured to cover the surface of the rear case 102. In particular, the backside cover 103 has a detachable configuration for user's convenience. If the backside cover 103 is detached from the rear case 102, the surface of the rear case 102 is exposed.

Referring to FIG. 2, if the backside cover 103 is attached to the rear case 102, a lateral side of the rear case 102 may be exposed in part. If a size of the backside cover 103 is decreased, a rear side of the rear case 102 may be exposed in part. If the backside cover 103 covers the whole rear side of the rear case 102, it may include an opening 103′ configured to expose a camera 121′ or an audio output unit 152′ externally.

The cases 101, 102 and 103 are formed by injection molding of synthetic resin or can be formed of metal substance such as stainless steel (STS), titanium (Ti) or the like for example.

A display 151, an audio output unit 152, a camera 121, user input units 130/131 and 132, a microphone 122, an interface 180 and the like can be provided to the case 101 or 102.

The display 151 occupies most of a main face of the front case 101. The audio output unit 152 and the camera 121 are provided to an area adjacent to one of both end portions of the display 151, while the user input unit 131 and the microphone 122 are provided to another area adjacent to the other end portion of the display 151. The user input unit 132 and the interface 170 can be provided to lateral sides of the front and rear cases 101 and 102.

The input unit 130 is manipulated to receive a command for controlling an operation of the terminal 100. And, the input unit 130 is able to include a plurality of manipulating units 131 and 132. The manipulating units 131 and 132 can be named a manipulating portion and may adopt any mechanism of a tactile manner that enables a user to perform a manipulation action by experiencing a tactile feeling.

Content inputted by the first or second manipulating unit 131 or 132 can be diversely set. For instance, such a command as start, end, scroll and the like is inputted to the first manipulating unit 131. And, a command for a volume adjustment of sound outputted from the audio output unit 152 and the like can be inputted to the second manipulating unit 132, a command for a switching to a touch recognizing mode of the display 151 and the like can be inputted to the second manipulating unit 133.

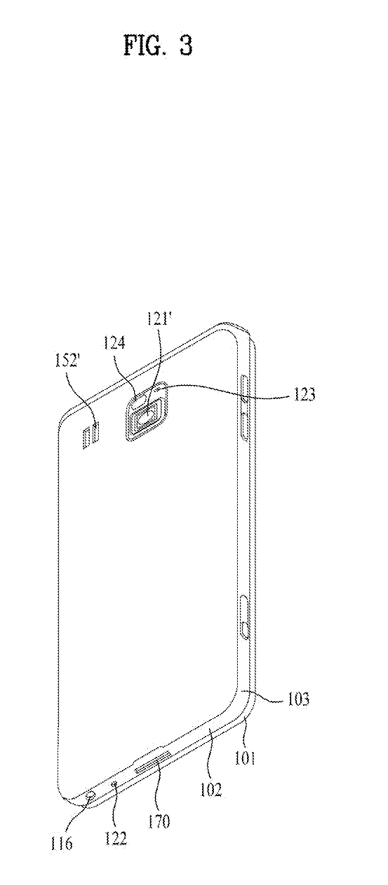

FIG. 3 is a perspective diagram of a backside of the terminal shown in FIG. 2.

Referring to FIG. 3, a camera 121′ can be additionally provided to a backside of the terminal body, and more particularly, to the rear case 102. The camera 121 has a photographing direction that is substantially opposite to that of the former camera 121 shown in FIG. 2 and may have pixels differing from those of the firmer camera 121.

Preferably, for instance, the former camera 121 has low pixels enough to capture and transmit a picture of user's face for a video call, while the latter camera 121′ has high pixels for capturing a general subject for photography without transmitting the captured subject. And, each of the cameras 121 and 121′ can be installed at the terminal body to be rotated or popped up.

A flash 123 and a mirror 124 are additionally provided adjacent to the camera 121′. The flash 123 projects light toward a subject in case of photographing the subject using the camera 121′. In case that a user attempts to take a picture of the user (self-photography) using the camera 121′, the mirror 124 enables the user to view user's face reflected by the mirror 124.

An additional audio output unit 152′ can be provided to the backside of the terminal body. The additional audio output unit 152′ is able to implement a stereo function together with the former audio output unit 152 shown in FIG. 2 and may be used for implementation of a speakerphone mode in talking over the terminal.

A broadcast signal receiving antenna 116 can be additionally provided to the lateral side of the terminal body as well as an antenna for communication or the like. The antenna 116 constructing a portion of the broadcast receiving module 111 shown in FIG. 1 can be retractably provided to the terminal body.

For clarity and convenience of the following description, assume that a mobile terminal 100 according to the present invention includes at least one of the components shown in FIG. 1. In particular, assume that the mobile terminal 100 according to the present invention includes the wireless communication unit 110, the display unit 151, the memory 160 and the controller 180 among the components shown in FIG. 1.

If the display unit 151 of the mobile terminal 100 includes a touchscreen, implementation of the mobile terminal 100 according to the present invention can be facilitated. Hence, assume that the display unit 151 includes the touchscreen. If the display module or unit 151 includes the touchscreen, the display unit 151 can play both a role as an output device for displaying information and a role as an input device for receiving a user input. If the display unit 151 does not include the touchscreen, the mobile terminal 100 according to the present invention may further include a separate input device (e.g., a physical button, etc.) configured to receive a user input. Yet, even if the display unit 151 includes the touchscreen, it is a matter of course that the mobile terminal 100 can further include the separate input unit.

In the following description, a mobile terminal 100 according to the present invention is explained in detail with reference to the accompanying drawings.

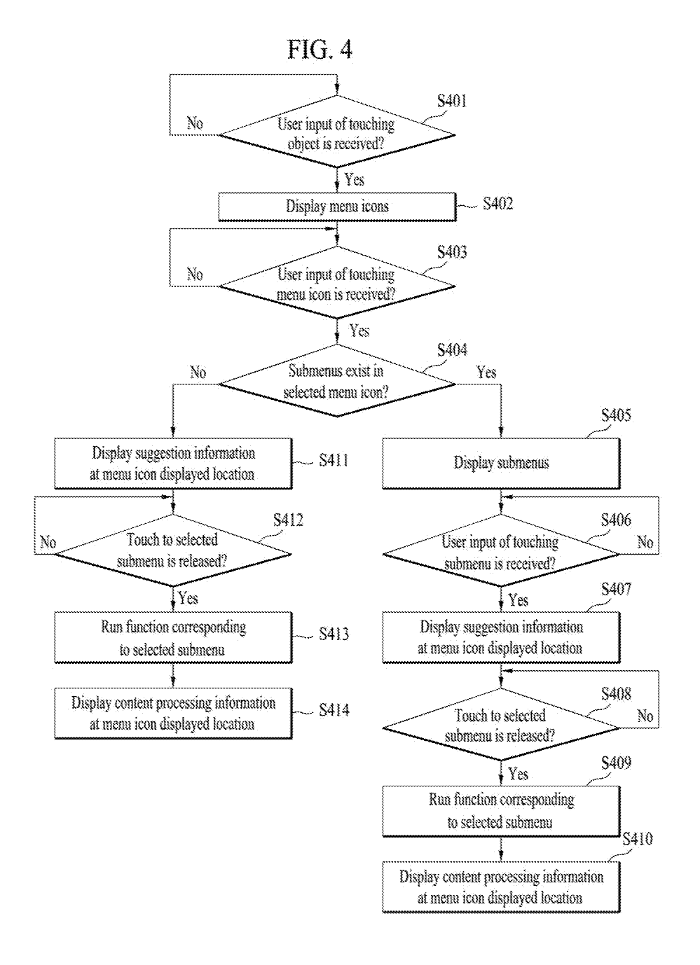

FIG. 4 is a flowchart for an operation of a mobile terminal 100 according to one embodiment of the present invention. First of all, assume that the mobile terminal 100 according to the present invention is in a state that an object related to a prescribed content is currently displayed. Contents mentioned in the description of the present invention include various kinds of information (e.g., image, video, music, document, map, webpage, etc.) that can be handled by the mobile terminal 100. And, objects related to contents can include a thumbnail image of a content, an icon for running a content, a text having a hyperlink (i.e., an object hyperlinked to a text can be regarded as a content mentioned in the description of the present invention), a region assigned for a corresponding content in a content list, and the like. For clarity of the following description, an object related to a content shall be named ‘object’.

Referring to FIG. 4, if a user input of touching an object is received [S401], the controller 180 can display a menu icon for processing a content corresponding to the object selected by the user input [S402]. In this case, the user input of touching the object can be implemented with one of various input examples including a case of touching an object with a single pointer, a case of touching an object with a predefined number of pointers, a case of proximately touching an object with a pointer, and the like.

The controller 180 can control the menu icon to be displayed as soon as the object is touched with a pointer. Alternatively, the controller 180 can control the menu icon to be displayed after a lapse of a prescribed time while the object is touched.

Moreover, the menu icon can be displayed while the display unit 151 is touched with a pointer only. After the touch has been released from the display unit 151, if the display unit 151 is not retouched with the pointer, the menu icon may stop being displayed after a lapse of a prescribed time.

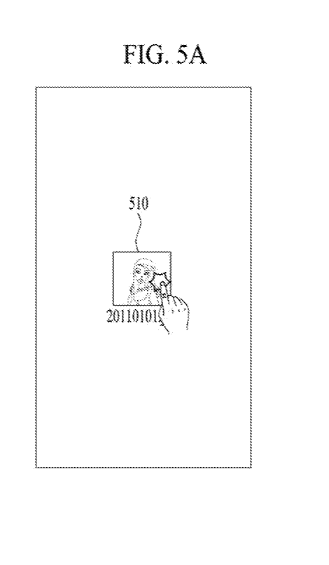

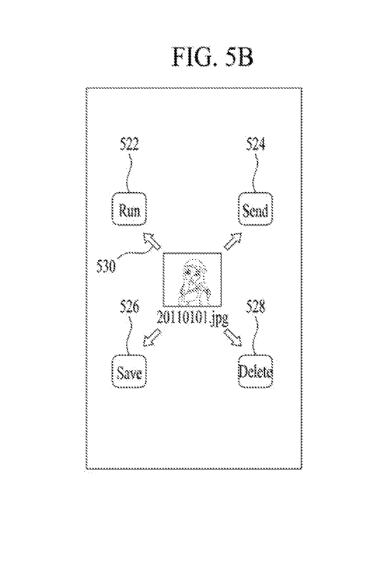

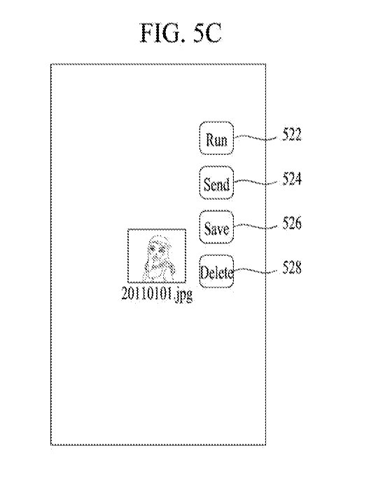

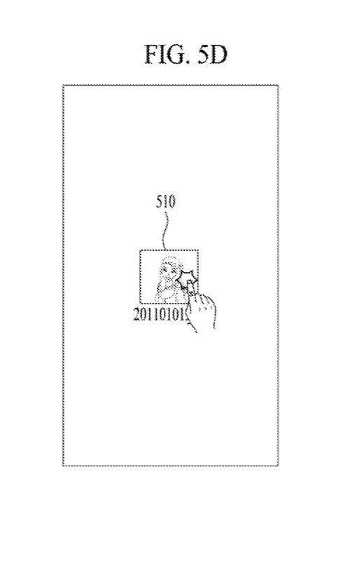

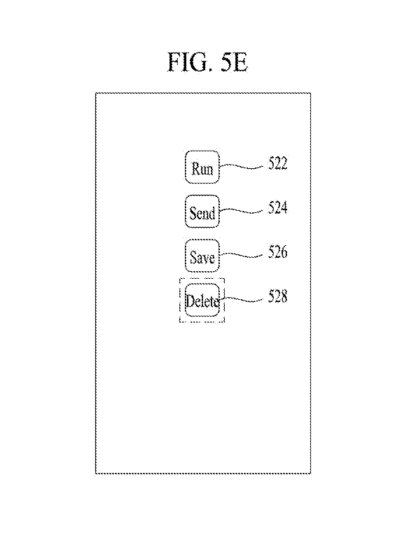

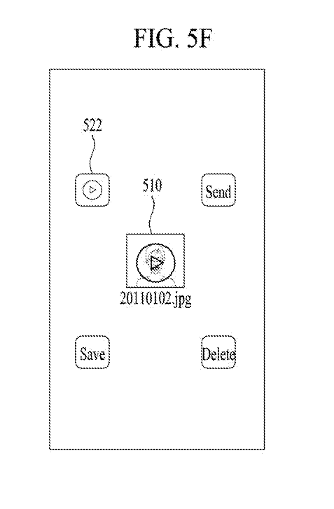

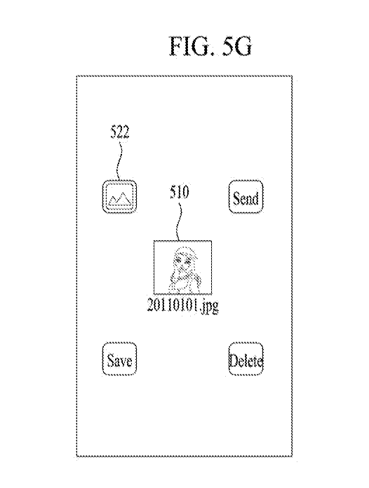

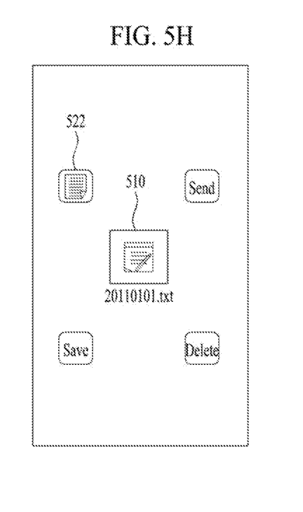

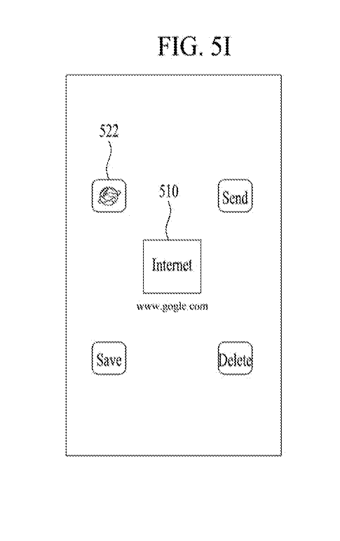

One example of displaying menu icons on the display unit 151 is described in detail with reference to FIGS. 5A to 5I as follows.

FIGS. 5A to 5C are diagrams to describe one example of displaying menu icons on the display unit 151.

Referring to FIGS. 5A to 5C, if a touch input to an object 510 is received [FIG. 5A], the controller 180 can control menu icons 522, 524, 526 and 528 for processing a content corresponding to the object 510 to be displayed [FIG. 5B]. In particular, referring to FIG. 5B and FIG. 5C, the controller 180 can control at least one or more menu icons 522, 524, 526 and 528 to be displayed around the object 510.

Like the example shown in FIG. 5B, the controller 180 can control the at least one or more menu icons 522, 524, 526 and 528 to be deployed in a manner of enclosing the selected object 510. Like the example shown in FIG. 5C, the controller 180 can control the at least one or more menu icons 522, 524, 526 and 528 to be deployed in a manner of forming a straight line.

Like the example shown in FIG. 5B, the controller 180 may control an arrow indicator 530 to be displayed in a manner of indicating a direction in which a corresponding menu icon is placed with reference to the object 510. If a pointer moves to a prescribed menu icon from the object 510 along the arrow indicator 530, the controller 180 can run a function indicated by the prescribed menu icon.

As examples of menu icons, FIG. 5B and FIG. 5C show a run icon 522 for running a content corresponding to the object 510, a send icon 524 for sending the content corresponding to the object 510 externally, a save icon 526 for saving the content corresponding to the object 510, and a delete icon 528 for deleting the content corresponding to the object 510. The present invention is non-limited by the examples shown in FIG. 5B and FIG. 5C. The mobile terminal 100 according to the present invention may display at least one portion of the menu icons shown in FIG. 5B and FIG. 5C. And, the mobile terminal 100 according to the present invention may further display menu icons failing to be shown in FIG. 5B and FIG. 5C. For instance, a copy icon for copying the content corresponding to the object 510 to a clipboard, an edit icon for editing the content (e.g., an image, a video, etc.) corresponding to the object 510, a lock icon for adjusting deletion authority of the content corresponding to the object 510 and the like may be displayed on the display unit 151.

FIG. 5B and FIG. 5C show one example that the at least one or more menu icons 522, 524, 526 and 528 are displayed around the object 510. If the object 510 is selected, the mobile terminal 100 according to the present invention stops displaying the selected object 510 and can control the at least one or more menu icons 522, 524, 526 and 528 to be displayed at a location where the object 510 was displayed. For instance, FIG. 5B shows one example of displaying at least one or more menu icons 522, 524, 526 and 528 at a location where the object 510 was displayed.

Referring to FIGS. 5D to 5E, if a touch input to a displayed object 510 is received [FIG. 5D], the controller 180 stops displaying the object 510 and is able to control menu icons 522, 524, 526 and 528 to be displayed in a region where the object 510 was displayed [FIG. 5E).

A shape of a menu icon can be changed in accordance with a content type. For instance, FIGS. 5F to 5I is a diagram for one example of changing a shape of a menu icon in accordance with a content type. If a selected object 510 is related to a video or music, like the example shown in FIG. 5F, the controller 180 can control a run icon 522 to be displayed in a first shape (e.g., a triangular icon indicating that a video or music will be played). If the selected object 510 is related to a photo, like the example shown in FIG. 5G, the controller can control the run icon 522 to be displayed in a second shape. If the selected object 510 is related to a text, like the example shown in FIG. 5H, the controller can control the run icon 522 to be displayed in a third shape. If the selected object 510 is related to a webpage, like the example shown in FIG. 5I, the controller can control the run icon 522 to be displayed in a fourth shape. Moreover, it is a matter of course that shapes of other menu icons are changeable in accordance with types of contents as well as the shape of the run icon 522.

In case that a selected object is a text having a hyperlink, a shape of a menu icon can be changed in accordance with an object linked to the text. For instance, if an object hyperlinked to a selected text is related to a video or music, like the example shown in FIG. 5F, a run icon can have a first shape. For instance, if an object hyperlinked to a selected text is related to a photo, like the example shown in FIG. 5G, a run icon can have a second shape.

A type of a menu icon to be displayed is changeable in accordance with attribute of a content and a user's setting. For instance, if an object of a content having a deletion authority is selected, a delete icon may be displayable. Yet, if an object of a content having no deletion authority is selected, a display of the delete icon can be omitted.

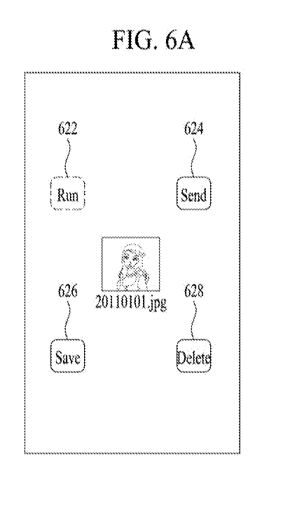

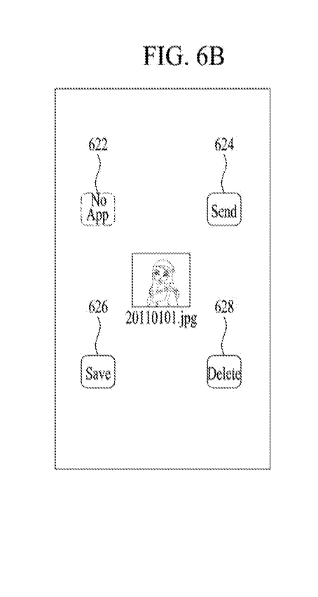

For another instance, the controller 180 displays the same menu icon for each content. Yet, in accordance with an attribute of a content, the controller 180 controls prescribed menu icons to be displayed in a manner of being activated but also controls prescribed menu icons to be displayed in a manner of being deactivated. One example of controlling menu icons to be displayed in a manner of being activated or deactivated is described with reference to FIGS. 6A and 6B as follows.

FIGS. 6A and 6B are diagrams for one example of displaying activated menu icons and deactivated menu icons. For clarity of the following description, if an object is selected, assume that a run icon 622, a send icon 624, a save icon 626 and a delete icon 628 are displayed as menu icons.

Referring to FIGS. 6A and 6B, if an application suitable for running a content corresponding to a selected object is not installed, like the example shown in FIG. 6A, the controller 180 can control the run icon 622 to be displayed in a manner of being deactivated. In particular, the controller 180 can control the run icon 622 in a deactivated state to be visually identifiable in a manner that the run icon 622 in the deactivated state is displayed more blurred than the rest of the menu icons 624, 626 and 628 in the activated state or transparently. According to the example shown in FIG. 6A, the run icon 622 in the deactivated state is represented as a dotted line.

The controller 180 can control the reason for setting the menu icon to the deactivated state to be displayed on the run icon 622 in the deactivated state. For instance, since an application suitable for running a content is not installed, if the run icon is set to the deactivated state, like the example shown in FIG. 6B, the controller 180 can control a guide text ‘No App’ (i.e., No runnable applications) to be displayed.

Moreover, the send icon 624, the save icon 626, the delete icon 629 and the like can be displayed as the deactivated state as well as the run icon 622. For instance, in one of a case that the mobile terminal 100 is operating in airplane mode (i.e., a state that an access to a network is interrupted), a case that an application suitable for file transmission is not installed, and a case that a user is not subscribed for a transmission service suitable for a file transmission, the controller 180 can control the send icon 624 to be displayed in a manner of being deactivated. If a space for saving a content is not sufficient in the memory 160 or a content has a read-only attribute, the controller 180 can control the save icon 626 to be displayed in a manner of being deactivated. If a content is not provided with deletion authority, the controller 180 can control the delete icon 628 to be displayed in a manner of being deactivated.

For clarity of the following description, as an object is selected, assume that run, send, save and delete icons are displayed as menu icons. This assumption is made for clarity of the description only, by which the present invention is non-limited.

For the description of the present invention, referring now to FIG. 4, if a user input for selecting a menu icon is received [S403], the controller 180 can take an appropriate action depending on whether a submenu subordinate to the menu icon selected by the user input is present [S404]. In this case, the user input for selecting a menu icon may include one of an action of dragging to move a pointer to a menu icon from an object, an action of touching a menu icon with one pointer while an object is touched with another pointer, and an action of receiving a touch input to a menu icon after releasing a touch from an object. Moreover, the controller 180 can control the menu icon, which is selected by the user input, to be displayed in a manner of being visually identifiable.

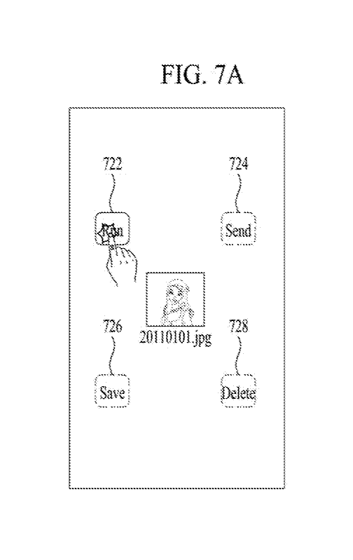

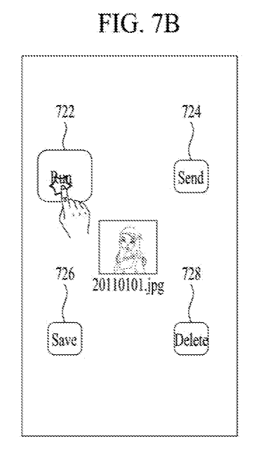

For instance, FIGS. 7A and 7B are diagrams for one example of displaying a selected menu icon visually and identifiably.

Referring to FIGS. 7A and 7B, if a menu icon 722 is selected by a user input, like the example shown in FIG. 7A, the controller 180 can control a fade-out effect to be applied to remaining menu icons 724, 726 and 728 except the selected menu icon 722. In particular, in FIG. 7A, the fade-out effect applied menu icons 724, 726 and 728 are represented as dotted lines. Hence, the selected menu icon 722 becomes more outstanding than the rest of the menu icons 724, 726 and 728. For another example, like the example shown in FIG. 7B, the controller 180 can control the selected menu icon 722 to be displayed larger than the rest of the menu icons 724, 726 and 728 in a manner of being enlarged. Besides, it is a matter of course that various methods of displaying a selected menu icon visually and identifiably are applicable as well as the examples shown in FIGS. 7A and 7B.

If submenus subordinate to a menu icon exist, the controller 180 can control submenus subordinate to the selected menu icon to be displayed [S405]. In doing so, the controller 180 can display the submenus subordinate to the selected menu icon as a list or icon form. For clarity, according to embodiments of the present invention mentioned in the following description, submenus subordinate to the selected menu icon are displayed as icons for example.

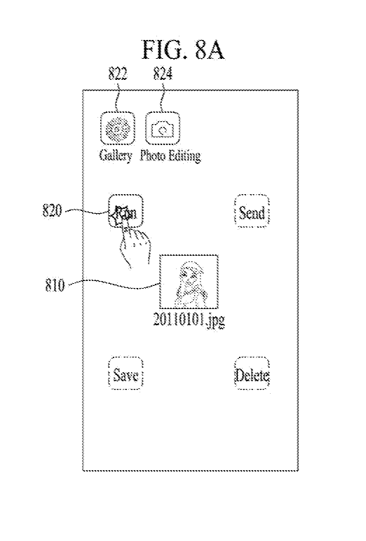

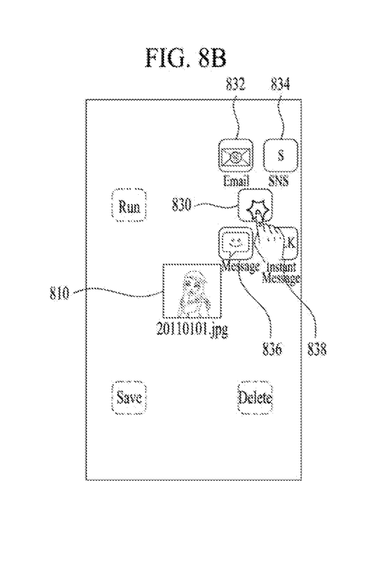

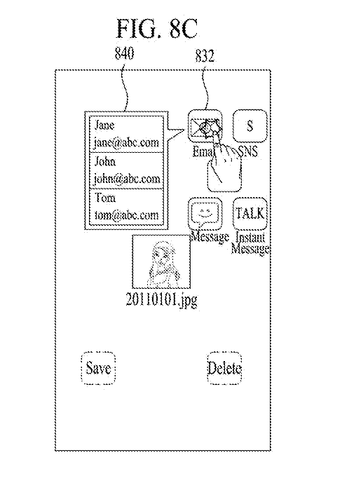

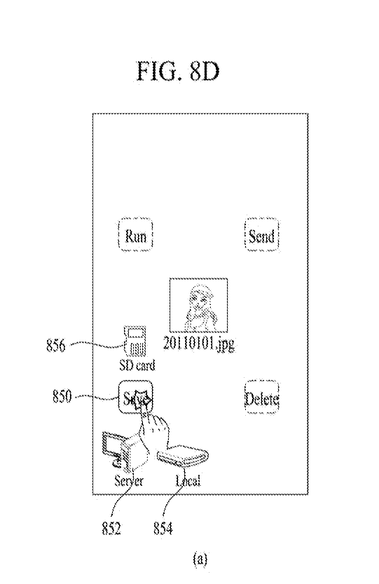

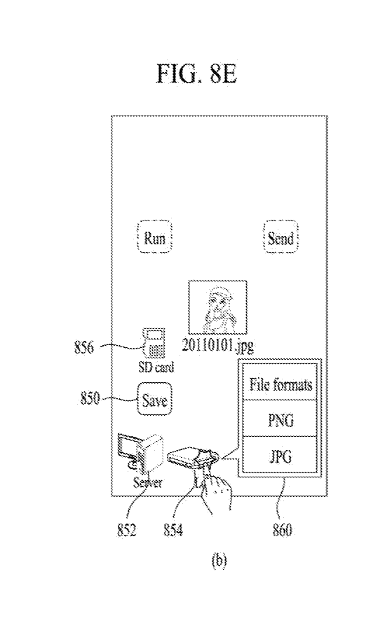

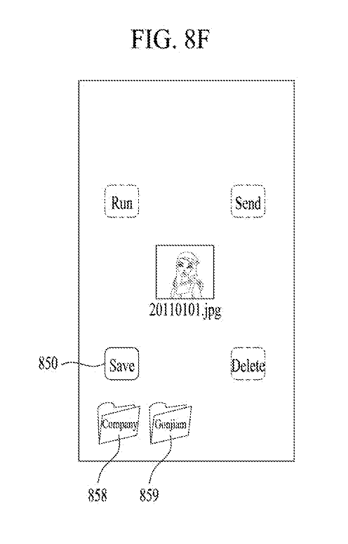

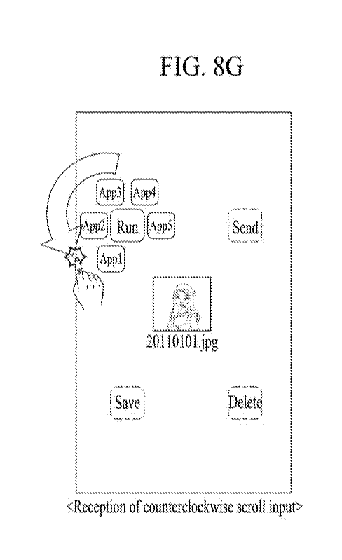

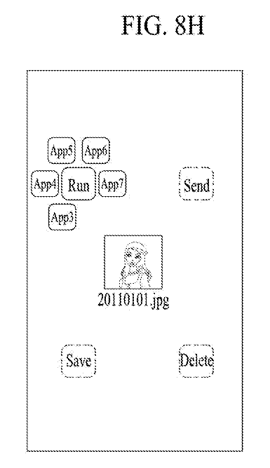

FIGS. 8A to 8H are diagrams for examples of displaying sub-menu icons subordinate to a selected menu icon. If a pointer is dragged to move to a menu icon from an object, the controller 180 can control a submenu icon to be displayed around the menu icon selected by a touch input.

For instance, if a run icon 820 is selected, like the example shown in FIG. 8A, the controller 180 can control icons 822 and 824 of applications, which can handle a content corresponding to an object, to be displayed as submenus. For instance, if a content corresponding to an object 810 is a photo file, like the example shown in FIG. 8A, the controller 180 can control icons of applications capable of handling photo files (e.g., an application (e.g., a gallery application 822) capable of running a photo, an application 824 capable of editing a photo, etc.) to be displayed around the run icon 820.

For another instance, if a send icon 830 is selected, like the example shown in FIG. 8B, the controller 180 can control communications means icons 832, 834, 836 and 838, which indicate means for sending a content corresponding to an object externally, to be displayed as submenu icons of the run icon. In this case, the communication means for sending contents externally can include at least one of an email, SNS (social network service), a message (e.g., MMS, etc.), an instant message (IM) and the like. The email icon 832 shown in FIG. 8B may be provided to select an email as a content sending means. And, the Facebook icon 834 may be provided to select an SNS as a sending means. Moreover, the message icon 836 may be provided to select a message as a sending means and the Kakao Talk icon 838 may be provided to select an instant message as a sending means.

In doing so, if one of the submenu icons shown in FIG. 8B is selected, like the example shown in FIG. 8C, the controller 180 can control a counterpart list 840, which is provided to specify a counterpart as a target to send a content using the selected communication means, to be displayed. In the counterpart list 840, an identification information on at least one counterpart can be included. In this case, the identification information on the counterpart can include at least one of a name, ID (identification), phone number and email address of the counterpart. If a counterpart to send a content is already specified, the counterpart list 840 shown in FIG. 8C can be omitted. Unlike the example shown in FIG. 8C, information on each counterpart can be displayed as an icon around a selected submenu.

If a save icon 850 is selected, like the example shown in FIG. 8D, the controller 180 can control icons 852, 854 and 856, which are provided to select a location for saving a content corresponding to an object, to be displayed as submenu icons of the save icon 850. According to the example shown in FIG. 8D, the server icon 852 may be provided to save a photo file in a web storage (or a cloud server). The local icon 854 may be provided to save a photo file in a local storage 160 (i.e., the memory 160). And, the SD card icon 856 may be provided to save a photo file in an SD card.

In doing so, if one of the submenu icons 852, 854 and 856 shown in FIG. 8D is selected, like the example shown in FIG. 8E, when a content is saved at a selected location, the controller 180 can control a format list 860, which is provided to select a file format of the content to be saved, to be displayed. According to the example shown in FIG. 8E, ‘PNG’ may indicate a format for saving a photo file in PNG file format and ‘jpg’ may indicate a format for saving a photo file in jpg file format. If a file format of a content to be saved is already specified, the format list 860 shown in FIG. 8E may be omitted. Unlike the example shown in FIG. 8E, the controller 180 displays a plurality of icons instead of the format list and is then able to control each icon to indicate a specific file format.

Although FIGS. 8D and 8E shows that a location for saving a content can be selected by storage unit, it is a matter of course that a location for saving a content can be selected by folder unit.

In displaying a submenu provided to select a location for saving a content, the controller 180 can control a location, in which a content having a meta information similar to a selected content is saved, to be displayed as a submenu. In this case, if the selected content is a photo, the content having the meta information similar to the selected content may include a photo or video identical to the selected photo in at least one of an information on a photographed location, an information on a photographed character and an information on a photographed day. If the selected content is a music file, the content having the meta information similar to the selected music file may include a music file categorized into a same album or genre.

For instance, FIG. 8F is a diagram for one example that a location, in which a content having a meta information similar to a selected content is saved, is displayed as a submenu. For clarity of the following description, assume that a selected content is a photo file.

Referring to FIG. 8F, if a save icon 850 for saving a selected photo file is selected, the controller 180 can control a location, in which a photo file having a meta information similar to the selected photo file is saved, to be displayed as a submenu. For instance, according to the example shown in FIG. 8F, a folder ‘company’ 858 may be a folder in which a photo of the same character in the selected photo file is saved. And, a folder ‘Gonjiam’ 859 may be a folder in which a photo taken at the same place of the selected photo file is saved. For user's recognition convenience, the controller 180 can control a thumbnail of a photo file, which has a meta information similar to the selected photo file, to be displayed on a submenu icon [not shown in FIG. 8F].

If the number of submenus subordinate to a specific menu icon is equal to or greater than a predetermined number, the controller 180 displays a predetermined number of submenus in the first place. If a scroll input is applied, the controller 180 can control a new submenu to be displayed by making the displayed old submenus disappear. For instance, like the example shown in FIG. 8G, the controller 180 can control a predetermined number of submenu icons to be displayed around a selected menu icon. The predetermined number of submenu icons may be deployed around the selected menu icon by forming a circle [FIG. 8G], by which the deployment of the submenu icons is non-limited. Subsequently, if a scroll input (e.g., an action of dragging a pointer along a curve trace) [FIG. 8G], the controller 180 controls some of the displayed submenus to disappear and is also able to control new submenus to be displayed as many as the number of the disappearing submenus. According to the example shown in FIG. 8H, icons App1 and App2 disappear but icons APP6 and APP7 are newly displayed.

Thereafter, if one of the submenus subordinate to the menu icon is touched [S406], the controller 180 can control an information (hereinafter named ‘suggestion information’), which suggests a method of processing a content corresponding to an object, to be displayed at a location where the menu icon was displayed [S407]. In this case, a user input for touching a submenu may include an action of dragging to move a pointer from a menu icon to a submenu, an action of touching a submenu with one pointer while touching a prescribed menu icon with another pointer, or an action of applying a touch input to a submenu icon after releasing a touch from a menu icon. And, the suggestion information may include one of an information (e.g., an application icon, a title of an application, a screen outputted on running an application, etc.) on an application capable of handling a content, an information (e.g., an icon representing a sending means, a name of a sending means, etc.) representing a sending means used in sending a content externally, an information (e.g., a name of a counterpart to receive a content, an ID of a counterpart to receive a content, a phone number of a counterpart to receive a content, etc.) on a counterpart to receive a content, an information on a saved location of a content, an information on a file format of a content to be saved, and the like.

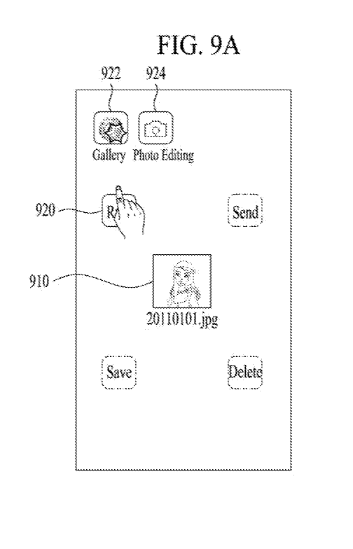

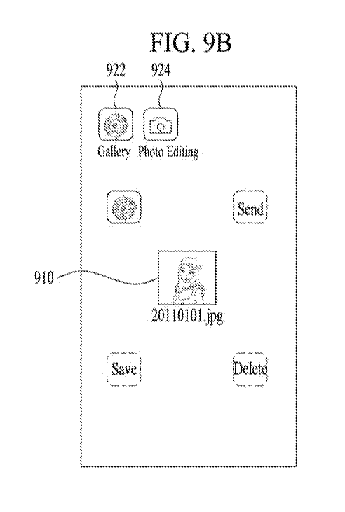

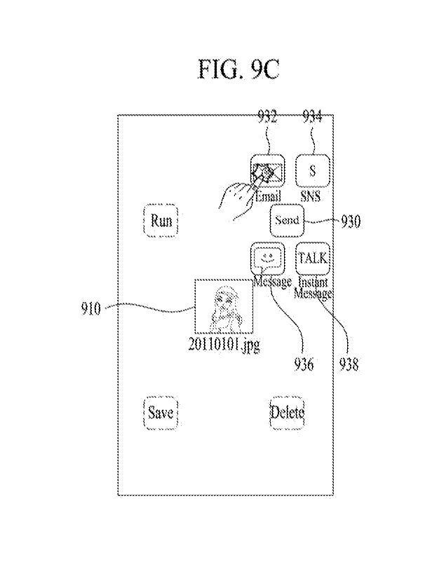

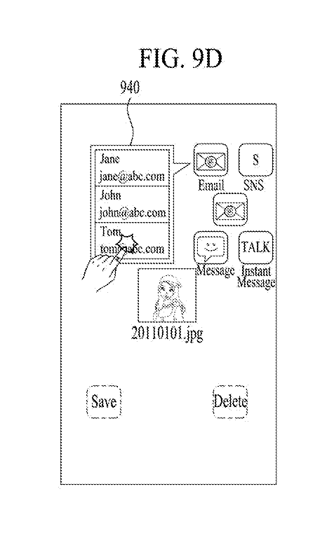

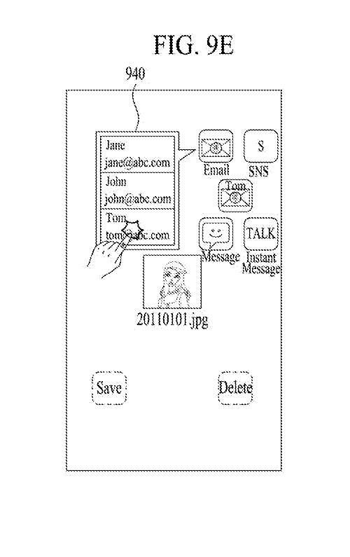

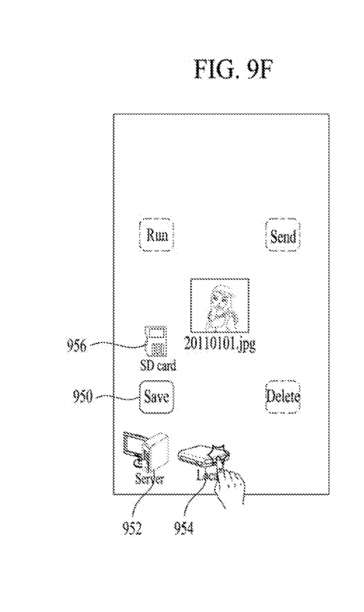

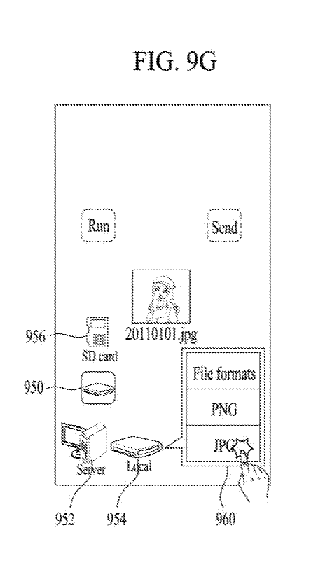

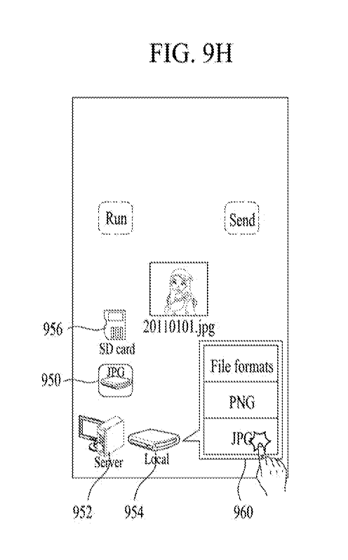

FIGS. 9A to 9H are diagrams for examples of displaying suggestion information for suggesting a content processing method at a location where a menu icon was displayed. FIGS. 9A to 9B show one example of an operation in case of selecting a submenu icon of a run icon 920, FIGS. 9C to 9E show one example of an operation in case of selecting a submenu icon of a send icon 930, and FIGS. 9F to 9H show one example of an operation in case of selecting a submenu icon of a save icon 950.

Referring to FIGS. 9A to 9B, while submenu icons 922 and 924 for the run icon 920 are displayed, if a user selects one of the submenu icons [FIG. 9A], the controller 180 can control a suggestion information, which suggests an application to be run to open a content, to be displayed at a location where the run icon 920 was displayed [FIG. 9B]. According to the example shown in FIG. 9B, an icon of a gallery application is illustrated as the suggestion information displayed at the location where the run icon 920 was displayed.

Like the example shown in FIG. 9B, the suggestion information suggesting a content processing method can be displayed in a manner of overlaying the corresponding menu icon. Unlike the example shown in FIG. 9B, the suggestion information may be displayed in a manner of replacing the corresponding menu icon.

Referring to FIGS. 9C to 9E, while submenu icons 932, 934, 936 and 938 for the send icon 930 are displayed, if a user selects one of the submenu icons [FIG. 9C], the controller 180 can control a suggestion information, which suggests a sending means for sending a content, to be displayed at a location where the send icon 930 was displayed [FIG. 9D]. According to the example shown in FIG. 9D, an email icon is illustrated as the suggestion information displayed at the location where the send icon 930 was displayed. In doing so, if a counterpart to whom a content will be sent using the selected sending means is selected (e.g., a specific character is selected from a counterpart list 940) [FIG. 9D], the controller 180 can control a suggestion information, which suggests the counterpart to send the content, to be displayed at the location where the send icon 930 was displayed [FIG. 9E]. According to the example shown in FIG. 9E, a name ‘TOM’ of the counterpart to receive the content is displayed as the suggestion information at the location where the send icon 930 was displayed.

Referring to FIGS. 9F to 9H, while submenu icons 952, 954 and 956 for the save icon 950 are displayed, if a user selects one of the submenu icons [FIG. 9F], the controller 180 can control a suggestion information, which suggests a saved location of a content, to be displayed at a location where the save icon 950 was displayed [FIG. 9G]. According to the example shown in FIG. 9G, an icon representing the saved location is illustrated as the suggestion information displayed at the location where the save icon 950 was displayed. In doing so, if a file format of a content to be saved is specified (e.g., a specific file format is selected from a format list 960) [FIG. 9G], the controller 180 can control a suggestion information, which suggests a saved format of the content to be displayed at the location where the save icon 950 was displayed [FIG. 9H]. According to the example shown in FIG. 9H, an information ‘PG’ indicating the saved format of the content is displayed as the suggestion information at the location where the save icon 950 was displayed.

While one of the submenus is selected, if the pointer is released from the touchscreen [S408], the controller 180 can run a function corresponding to the selected submenu [S409]. For instance, while one of the submenus of the run icon is selected, if the pointer is released from the touchscreen, the controller 180 can run an application indicated by the selected submenu. While one of the submenus of the send icon is selected, if the pointer is released from the touchscreen, the controller 180 can send the content using the sending means indicated by the selected submenu. For another instance, while one of the submenus of the save icon is selected, if the pointer is released from the touchscreen, the controller 180 can control the content to be saved at a location indicated by the selected submenu.

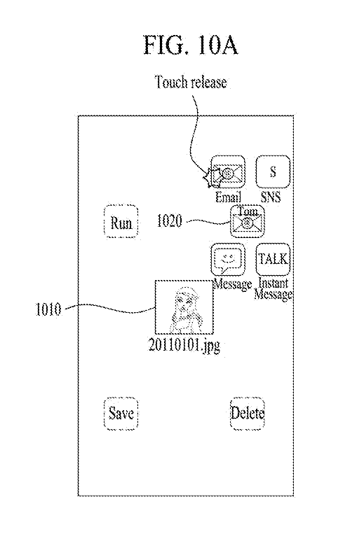

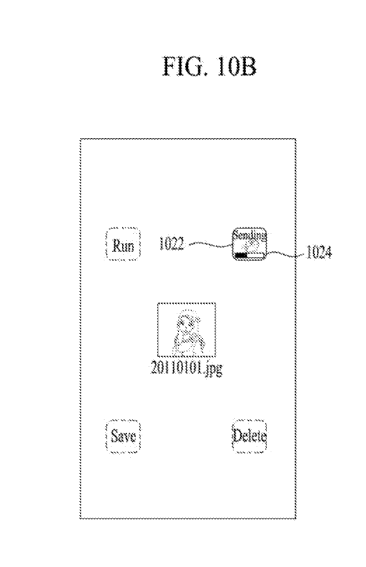

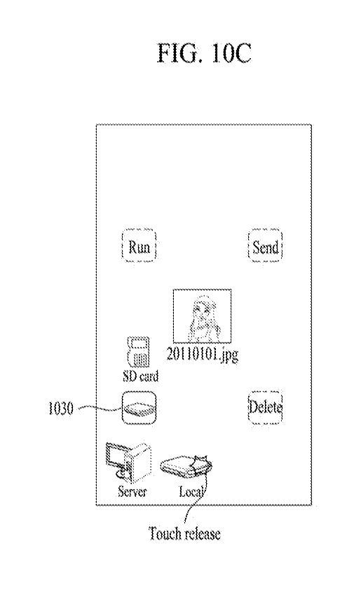

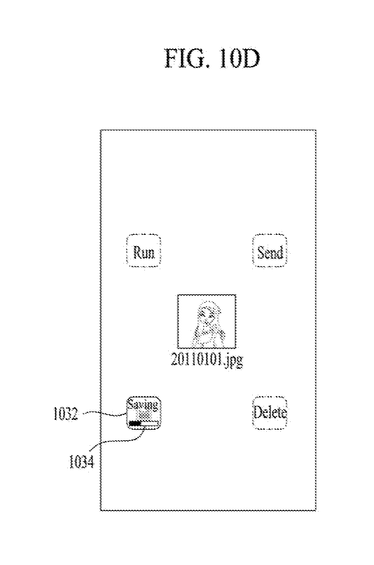

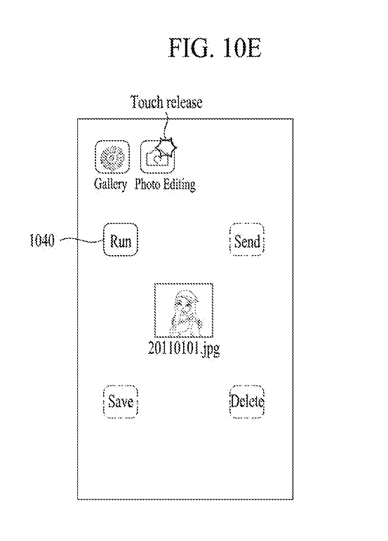

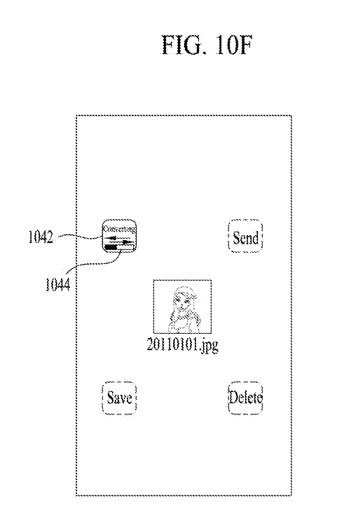

In doing so, the controller 180 can control a processed information of a content to be displayed at a location where a superordinate menu icon of the selected submenu was displayed [S410]. In this case, the processed information of the content may include at least one of a state information indicating a processed state of the content, a progress rate of sending the content, a progress rate of saving the content, a file format conversion rate of the content, a progress rate of deleting the content, and the like. One example of displaying a processed information at a location, where a menu icon was displayed, is described in detail with reference to FIGS. 10A to 10F as follows.

FIGS. 10A to 10F are diagrams for examples of displaying a content processed information at a location where a menu icon was displayed. FIGS. 10A and 10B are diagrams for one example of an operation in case of releasing a pointer from a touch in the course of selecting a submenu of a send icon 1020, FIGS. 10C and 10D are diagram for one example of an operation in case of releasing a pointer from a touch in the course of selecting a submenu of a save icon 1030, and FIGS. 10E and 10F are diagrams for one example of an operation in case of releasing a pointer from a touch in the course of selecting a submenu of a run icon 1040.

Referring to FIG. 10A, while one of submenus subordinate to the send icon 1020 is selected, if a pointer is released from a touchscreen, the controller 180 can control a content to be sent through a sending means specified by the selection of the submenu. In doing so, referring to FIG. 10B, the controller 180 can control a state information 1022, which indicates a sent state of the content, to be displayed at a location where the send icon 1020 was displayed. In this case, the state information 1022 can be represented as a text (e.g., ‘sending’, ‘sending completed’, etc.) or icon indicating that the content is being sent to a counterpart or that the content is completely sent to the counterpart.

Referring to FIG. 10B, the controller 180 can control a sending progress rate 1024, which indicates a complete rate of a transmission to the counterpart in a full size of the content, to be further displayed. The sending progress rate 1024 can be represented as a numerical value between 0 and 100%. Alternatively, the sending progress rate 1024 may be represented as a progress bar of which gauge increases in proportion to an increasing sending progress rate of the content.

Besides, before the content is sent to the counterpart, if a format of the content needs to be converted to a prescribed file format or the content needs to be resized into a prescribed size, the controller 180 can control a state information (e.g., a text ‘converting’, an icon indicating that a file format or size is changed, etc.) and a conversion progress rate to be displayed. In this case, the state information indicates that the content is being converted to a prescribed file format or a prescribed size. And, the conversion progress rate indicates a progress level of a file format conversion or resizing of the content.

Although FIG. 10B shows that the state information 1022 indicating the content sent state and the sending progress rate 1024 are displayed together, it is a matter of course that either the state information 1022 or the sending progress rate 1024 can be displayed at the location where the menu icon was displayed.

Referring to FIG. 10C, while one of submenus subordinate to the save icon 1030 is selected, if a pointer is released from a touchscreen, the controller 180 can control a content to be saved in a storage location selected by the selection of the submenu. In doing so, referring to FIG. 10D, the controller 180 can control a state information 1032, which indicates a saved state of the content, to be displayed at a location where the save icon 1030 was displayed. In this case, the state information 1032 can be represented as a text (e.g., ‘saving’, ‘saving completed’, etc.) or icon indicating that the content is being saved in a designated location or that the content is completely saved in the designated location.

Referring to FIG. 10D, the controller 180 can control a saving progress rate 1034, which indicates a complete rate of a saving in the designated location in a full size of the content, to be further displayed. The saving progress rate 1034 can be represented as a numerical value between 0 and 100%. Alternatively, the saving progress rate 1034 may be represented as a progress bar of which gauge increases in proportion to an increasing saving progress rate of the content.

Besides, before the content is saved in the designated location, if a format of the content needs to be converted to a prescribed file format, the controller 180 can control a state information (e.g., a text ‘converting’, an icon indicating that a file format is changed, etc.) and a conversion progress rate to be displayed. In this case, the state information indicates that the content is being converted to a prescribed file format. And, the conversion progress rate indicates a progress level of a file format conversion of the content.

Although FIG. 10D shows that the state information indicating the saved state of the content and the saving progress rate are displayed together, it is a matter of course that either the state information or the saving progress rate can be displayed at the location where the menu icon was displayed.

The content processing information displayed at the menu icon displayed location can be displayed in a manner of overlaying the menu icon. Alternatively, unlike the example shown in the drawing, the content processing information can be displayed in a manner of replacing the corresponding menu icon.

In case that a function corresponding to a submenu subordinate to the run icon 1040 is run (i.e., an application is run), since a running screen of the application is outputted through the display unit 151, it is not necessary to further display the corresponding menu icon. Hence, the step of displaying the content processing information can be skipped. Yet, if a function is runnable through an application corresponding to a selected submenu by converting a file format of a content corresponding to a selected object 101 only, the controller 180 can control the content processing information to be displayed at the run icon displayed location before running the corresponding application.

For instance, referring to FIG. 10E, while one of submenus subordinate to the run icon 1040 is selected, if a pointer is released from a touchscreen, the controller 180 can control a content to be run through an application selected by the submenu. In doing so, referring to FIG. 10F, if it is necessary to convert a file format of the content before running the application corresponding to the submenu (e.g., a case that the selected application handles the format ‘bmp’ only while the format of the content is the format ‘jpg’), the controller 180 can control a state information 1042, which indicates that the content is being converted to a prescribed file format, to be displayed at a location where the run icon 1040 was displayed. In this case, the state information 1042 can be represented as a text (e.g., ‘converting’, ‘conversion completed’, etc.) or icon indicating that the content is being converted to the prescribed file format.

Referring to FIG. 10F, the controller 180 can control a conversion progress rate 1044, which indicates a progress level of the conversion of the file format of the content, to be further displayed. The conversion progress rate can be represented as a numerical value between 0 and 100%. Alternatively, the conversion progress rate 1044 can be represented as a progress bar of which gauge increases in proportion to an increasing conversion progress rate of the content.

Although FIG. 10F shows that the state information indicating the conversion state of the content and the conversion progress rate are displayed together, it is a matter of course that either the state information or the conversion progress rate can be displayed at the location where the menu icon was displayed.

According to the example shown in FIG. 10F, if the conversion of the content to the file format that can be handled by the application corresponding to the selected submenu is completed, the controller 180 may be able to run the corresponding content through the application corresponding to the selected submenu.

If no submenu of the selected menu icon exists [S404], the controller 180 can control an information, which suggests a method of processing the content corresponding to the object, to be displayed at the location where the menu icon was displayed [S411]. In particular, if there is no submenu of the menu icon, the suggestion information can be displayed at the menu icon displayed location irrespective of a presence or non-presence of the selection of the submenu.

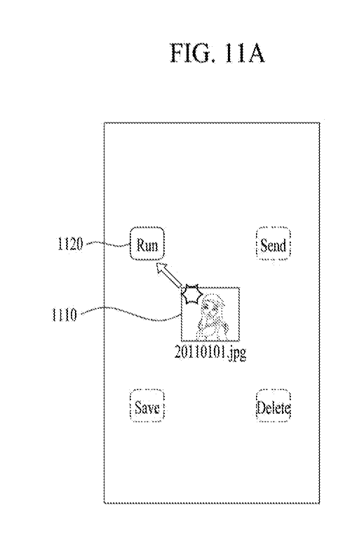

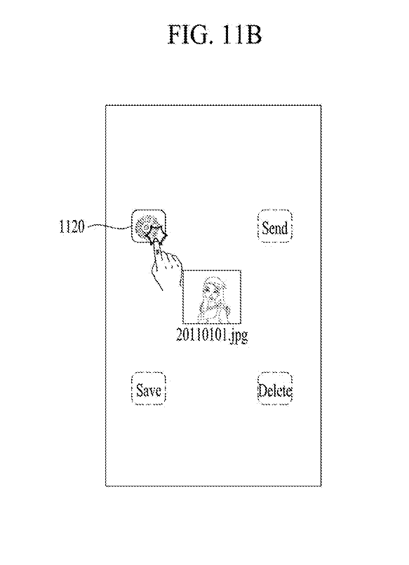

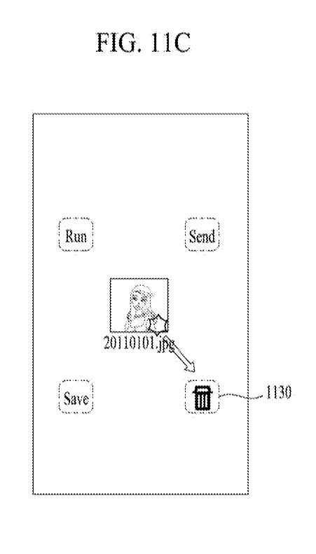

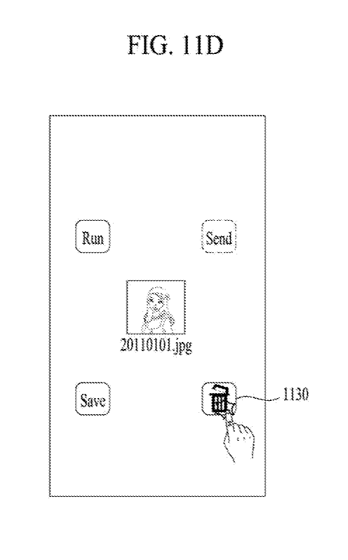

For instance, FIGS. 11A to 11D are diagrams for one example of displaying suggestion information at a location, where a menu icon was displayed, if the menu icon is selected. FIGS. 11A and 11B are diagrams for one example of an operation in case of selecting a run icon 1120. FIGS. 11C and 11D are diagrams for one example of an operation in case of selecting a delete icon 1130.

Referring to FIGS. 11A and 11B, if there is an application set to a default for running a content corresponding to an object 1110 selected by a user, a process for selecting an application for running a content through a submenu is not necessary. Hence, like the example shown in FIG. 11A and FIG. 11B, if a run icon 1120 is selected, the controller 180 can control an information of the default set application, which will be run to open the content, to be displayed at a location where the run icon 1120 was displayed.

Moreover, when a send icon is selected, if a sending means and counterpart set to default exist, it is a matter of course that a suggestion information can be displayed at a location, where the send icon was displayed, in case of selecting the send icon [not shown in the drawing].

Besides, when a save icon is selected, if a storage location and file format set to default exist, it is a matter of course that a suggestion information can be displayed at a location, where the save icon was displayed, in case of selecting the save icon.

Referring to FIGS. 11C and 11D, when a user selects a delete icon 1130, like the example shown in FIG. 11C and FIG. 11D, the controller 180 can control a shape of the delete ion 1130 to be changed. According to the example shown in FIG. 11C, an icon is displayed in a closed trash can shape. According to the example shown in FIG. 11D, an icon is displayed in an open trash can shape. Considering that the changed icon shape suggests a content processing method (i.e., suggesting that a selected content will be thrown into a trash can), the changed icon shape can be included in the suggestion information described in the present invention.

While the menu icon is selected, if the pointer is released from the touchscreen [S412], the controller 180 can run the function corresponding to the selected menu icon [S413]. In particular, the controller 180 may be able to run a function corresponding to the suggestion information. For instance, referring to FIGS. 11A and 11B, the controller 180 can run an application (i.e., a gallery application) corresponding to the suggestion information previously displayed at the run icon displayed location.

In doing so, the controller 180 can control the content process information to be displayed at the location where the selected menu icon was displayed [S414]. Since the operation of displaying the content processing information at the previous menu-icon displayed location can refer to the same description with reference to FIGS. 10A to 10F, its details shall be omitted from the following description. While a delete icon is selected, if a pointer is released from a touchscreen, it may be able to display a state information, which indicates that a content is being deleted, and a processing information such as a deletion progress rate and the like [not shown in FIGS. 10A to 10F].

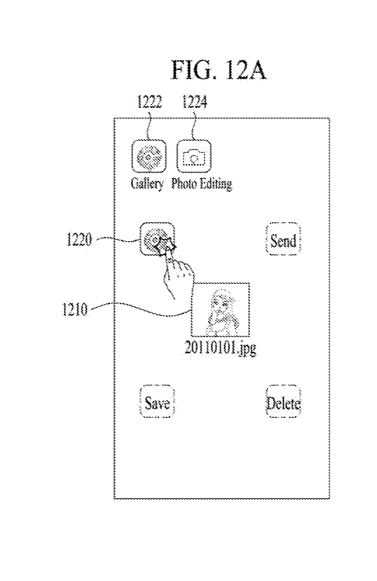

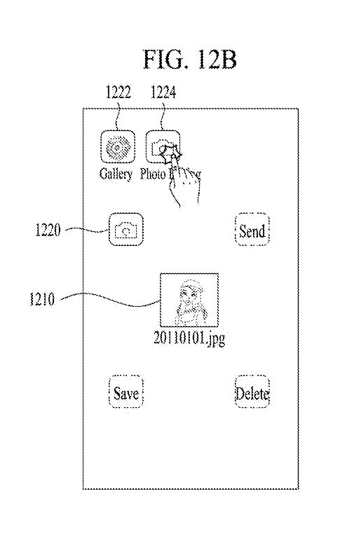

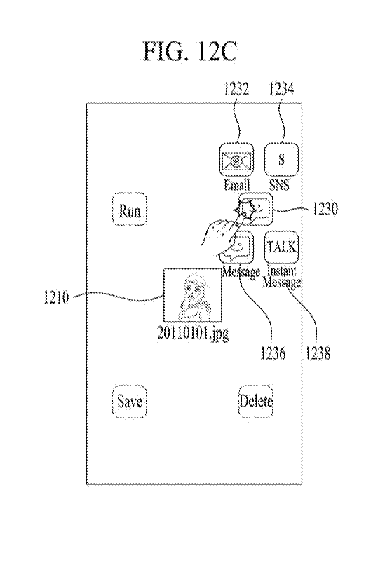

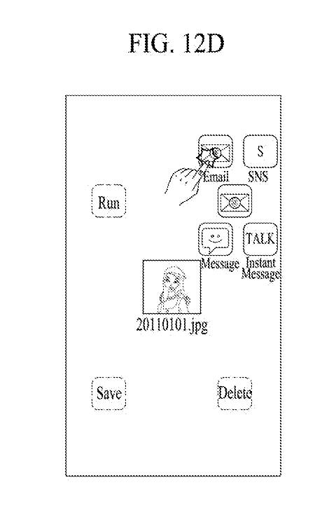

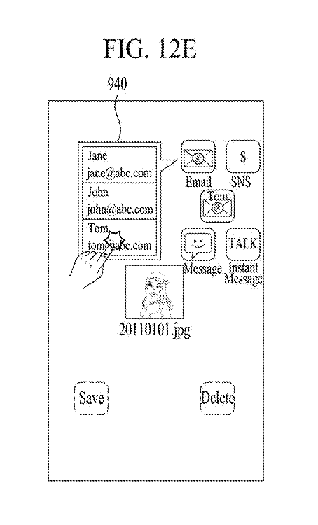

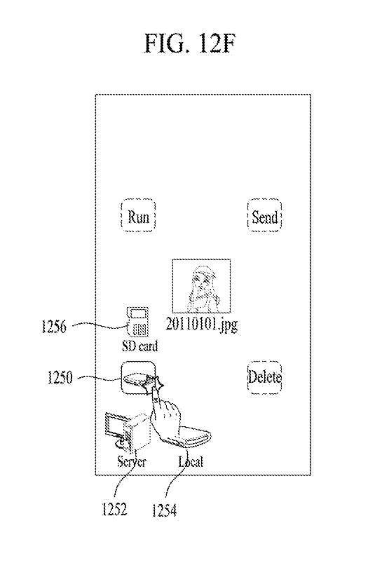

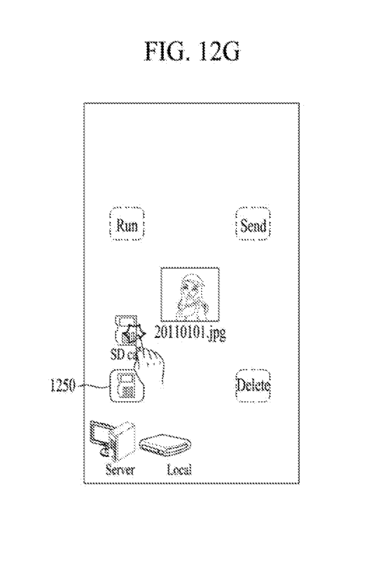

According to the example shown in FIG. 4, when the menu icon having the submenus is selected, only if the submenu subordinate to the menu icon is selected, the suggestion information suggesting the content processing method is displayed at the location where the menu icon was displayed [S406, S407]. The mobile terminal 100 according to the present invention can control a suggestion information to be displayed at a location, where a selected menu icon was displayed, before one of submenus subordinate to a menu icon is selected. In particular, the controller 180 can control a suggestion information, which is related to a method of processing a content having a highest use frequency of a user or a method of processing a content most recently utilized by a user, to be displayed. Thereafter, if a touch with a pointer is released without a step of selecting a submenu, the controller 180 can process a content using the method of processing a content having a highest use frequency of a user or the method of processing a content most recently utilized by a user. This is described in detail with reference to FIGS. 12A to 12C as follows.

FIGS. 12A to 12G are diagrams for examples of displaying suggestion information for suggesting a content processing method at a location where a menu icon was displayed. FIGS. 12A and 12B are diagrams for one example of an operation in case of selecting a run icon 1220. FIGS. 12C to 12E are diagrams for one example of an operation in case of selecting a delete icon 1230. And, FIGS. 12F and 12G are diagram for one example of an operation in case of selecting a save icon 1250.

Referring to FIGS. 12A and 12B, if the run icon 1220 is selected, like the example shown in FIG. 12A, the controller 180 can control submenus 1222 and 1224 subordinate to the run icon 1220 to be displayed. In doing so, although the submenu 1222 or 1224 subordinate to the run icon 1220 is not selected, like the example shown in FIG. 12A, the controller 180 can control a suggestion information, which suggests an application to be run, to be displayed at a location where the run icon 1220 was displayed. In particular, the controller 180 can control an information on an application, which is most recently run to open a content of the same type of a content selected by a user, or an information on an application, which is most frequently used to open the content of the same type of the selected content, to be displayed.

Before the submenu 1222 or 1224 is selected, if the pointer is released from the touchscreen, the controller 180 can run the application (i.e., the application most recently run by a user, an application most frequently used by a user, etc.) corresponding to the suggestion information.

Otherwise, one of the submenus 1222 and 1224 subordinate to the run icon 1220 is selected, referring to FIG. 12B, the controller 180 can control the suggestion information displayed on the dun icon 1220 to be changed into an application information corresponding to the selected submenu 1224. While the submenu is selected, if the pointer is released from the touchscreen, the controller 180 can run the application corresponding to the selected submenu.

Referring to FIGS. 12C and 12E, if a send icon 1230 is selected, like the example shown in FIG. 12C, the controller 180 can control submenus 1232, 1234, 1236 and 1238 subordinate to the send icon 1230 to be displayed. In doing so, although the submenu 1232, 1234, 1236 or 1238 subordinate to the send icon 1230 is not selected, like the example shown in FIG. 12C, the controller 180 can control a suggestion information, which suggests a sending means and a counterpart, to be displayed at a location where the send icon 1230 was displayed. In particular, the controller 180 can control an information representing a communication means most recently used by a user or a communication means most frequently used by a user and an information representing a counterpart most recently communicating with a user or a counterpart most frequently communicating with a user to be displayed. Before the submenu 1232, 1234, 1236 or 1238 is selected, if a pointer is released from a touchscreen, the controller 180 can attempt a content sending to a specific counterpart (e.g., a counterpart most recently communicating with a user, a counterpart most frequently communicating with a user, etc.) using the communication means (e.g., a communication means most recently used by a user, a communication means most frequently used by a user, etc.) corresponding to the suggestion information.

Otherwise, if one of the submenus 1232, 1234, 1236 and 1238 subordinate to the send icon 1230 is selected or a communication counterpart is specified (e.g., a specific counterpart is selected from a counterpart list 1240), like the example shown in FIG. 12D and FIG. 12E, the controller 180 can control the suggestion information displayed on the send icon 1230 to be changed into an information corresponding the selected submenu icon or the specified communication counterpart. While the submenu is selected, if a pointer is released from a touchscreen, the controller 180 can send a content to the specific counterpart using the communication means corresponding to the selected submenu.

Referring to FIGS. 12F and 12G, if a save icon 1250 is selected, like the example shown in FIG. 12F, the controller 180 can control submenus 1252, 1254 and 1256 subordinate to the save icon 1250 to be displayed. In doing so, although the submenu 1252, 1254 or 1256 subordinate to the save icon 1250 is not selected, like the example shown in FIG. 12G, the controller 180 can control a suggestion information, which suggests a storage location, to be displayed at a location where the save icon 1250 was displayed. In particular, the controller 180 can control an information on a location, where a user last saves a content of the same type of a selected content, or an information on a location, where a content having a meta information similar to the selected content is saved, to be displayed. In this case, if the selected content is a photo, the content having the meta information similar to the selected photo can include a photo or video of which information on at least one of a photographed location, a photographed character and a photographed date is identical to that of the selected photo. If the selected content is a music file, a content having a meta information similar to the selected music file may include a music file categorized into a same album or genre.

Before the submenu 1252, 1254 or 1256 is selected, if a pointer is released from a touchscreen, the controller 180 can save the content in a storage location (e.g., a location in which the content of the same type of the selected content is saved last, a location in which the content having information similar to the selected content is saved, etc.) corresponding to the suggestion information.

Otherwise, if one of the submenus 1252, 1254 and 1256 subordinate to the save icon 1250 is selected, like the example shown in FIG. 12G, the controller 180 can control the suggestion information displayed on the save icon 1250 to be changed into a location information indicated by the selected submenu icon.

While the submenu is selected, if the pointer is released from the touchscreen, the controller 180 can save the content in the storage location corresponding to the selected submenu.

According to the example shown in FIG. 4, if a user input of touching an object related to a content is received, a menu icon is displayed. The mobile terminal 100 according to the present invention can control a menu icon to be displayed even if a user input of touching a content itself is received.

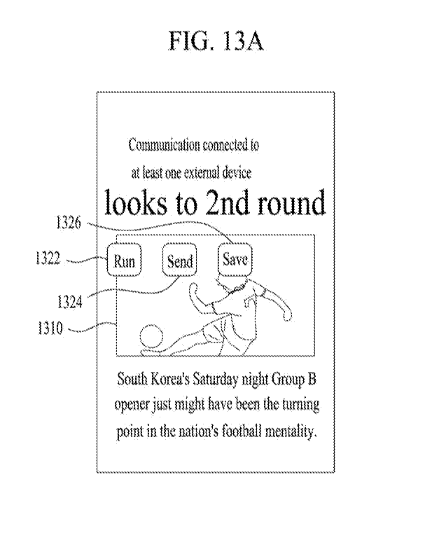

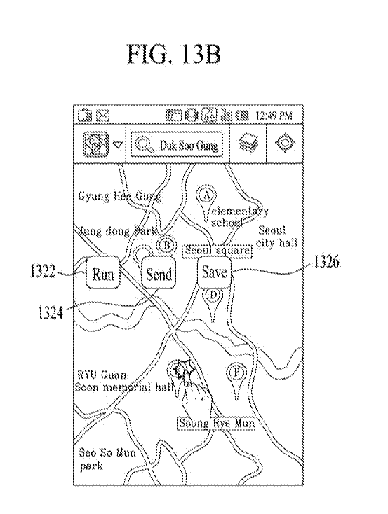

For instance, FIGS. 13A and 13B are diagrams to describe one example of an operation in case of receiving a touch input while a content is displayed.

FIG. 13A shows one example that a webpage including an image 1310 is outputted through the display unit 151. In this case, if a user input of touching the image 1310 included in the webpage is received, like the example shown in FIG. 13A, the controller 180 can control menu icons 1322, 1324 and 1326 for processing the selected content 1310 to be displayed. Using the menu icon 1322, 1324 or 1326, a user is able to determine whether to open a selected photo through a different application (e.g., a gallery application, etc.) (i.e., corresponding to a function of the run icon 1322), whether to send the selected photo to a specific counterpart (i.e., corresponding to a function of the send icon 1324), whether to save the selected photo (i.e., corresponding to a function of the save icon 1326), and the like.

FIG. 13B shows one example of a state that a map is currently outputted through the display unit 151. In this case, if specific coordinates 1330 is selected from the map, like the example shown in FIG. 13B, the controller 180 can control menu icons 1322, 1324 and 1326 for processing the selected coordinates 1330 to be displayed. Using the menu icon 1322, 1324 or 1326, a user is able to determine whether to open a URL address corresponding to the selected coordinates through a different application (e.g., a web browser, etc.), (i.e., corresponding to a function of the run icon 1322), whether to send the URL address corresponding to the selected coordinates to a specific counterpart (i.e., corresponding to the send icon 1324), whether to save the URL address corresponding to the selected coordinates (i.e., corresponding to the save icon 1326), and the like.

While a photo is taken, the menu icons described with reference to FIG. 4 can be displayed in case of receiving an appropriate user input.

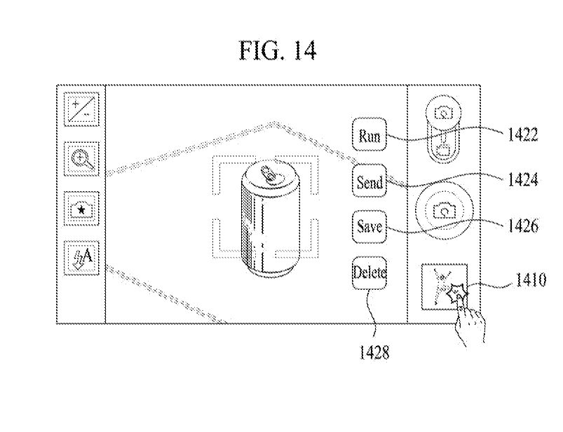

For instance, FIG. 14 is a diagram for one example of displaying a menu icon while a photo is taken.

Referring to FIG. 14, if a camera application is activated, the controller 180 outputs a preview image inputted from the camera 121 to the display unit 151 and is able to display various buttons (e.g., a photographing button, etc.) for photographing. In doing so, a thumbnail region 1410 for displaying a thumbnail image of a photo last taken by a user can be assigned to a photographing screen. If an appropriate user input is applied to the thumbnail region 1410, the controller 180 can control menu icons 1422, 1424, 1426 and 1428, which are provided to process a photo file corresponding to the thumbnail region 1410, to be displayed.

For instance, if the thumbnail region 1410 is touched, like the example shown in FIG. 14, the controller 180 can control the menu icons 1422, 1424, 1426 and 1428, which are provided to process a photo file displayed through the thumbnail region 1410, to be displayed. Using the menu icons, a user is able to determine whether to open the selected photo file (i.e., corresponding to the run icon 1422), whether to send the selected photo file to a specific counterpart (i.e., corresponding to the send icon 1424), whether to change a storage location of the selected photo file (i.e., corresponding to the save button 1426), whether to delete the selected photo file (i.e., corresponding to the delete button 1428), and the like. If the menu icons are set to be displayed in the course of taking a photo, a user can easily perform an operation of running a just-taken photo, an operation of sending a just-taken photo, an operation of changing a storage location of a just-taken photo, an operation of deleting a just-taken photo, and the like.

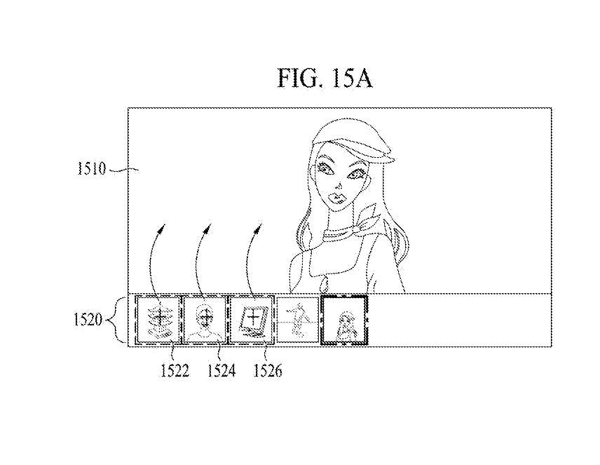

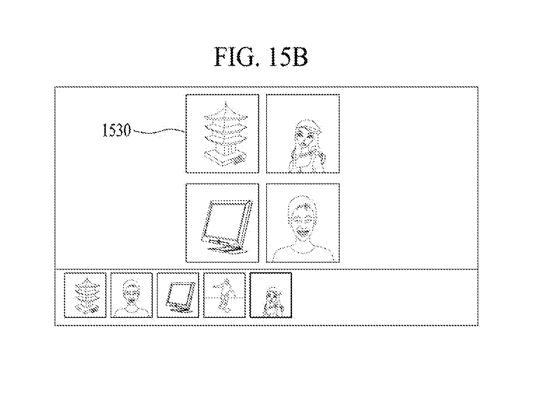

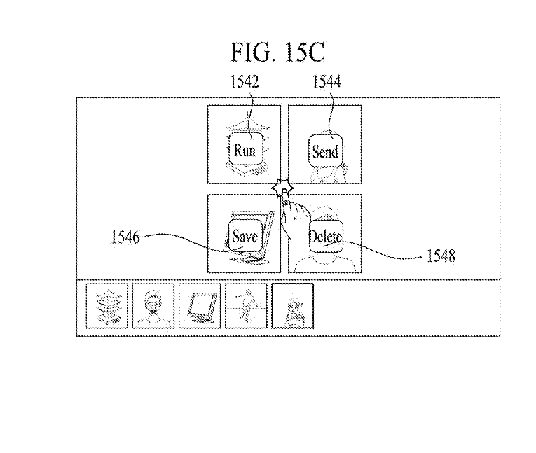

The mobile terminal 100 according to the present invention groups a plurality of contents and is then able to control menu icons to be displayed by targeting the grouped contents. This is described in detail with reference to FIG. 15 as follows.

FIGS. 15A to 15C are diagrams for one example of displaying menu icons by grouping a plurality of contents and targeting a grouped content. For clarity of the following description, assume that a gallery application for watching a photo file is running in the mobile terminal 100.

Referring to FIGS. 15A to 15C, if a gallery application is run, like the example shown in FIG. 15A, the controller 180 can control a photo file list 1520 saved in the mobile terminal 100 to be displayed while outputting a specific photo file 1510. In doing so, if at least one photo file in the photo file list is dragged to the specific photo file 1510, like the example shown in FIG. 15B, the controller 180 can group the specific photo file 1510 and photos 1522, 1524 and 1526 selected from the photo file list 1520 into one group 1530.

Thereafter, if a user input of selecting the grouped photo file 1530 is received, like the example shown in FIG. 15C, the controller 180 can control menu icons 1542, 1544, 1546 and 1548, which are provided to process the grouped photo file 1530, to be displayed. Using the menu icons 1542, 1544, 1546 and 1548, a user is able to determine whether to run an application for running a plurality of photos belonging to one group (i.e., corresponding to the run icon 1542), whether to send a plurality of photos to a specific counterpart (i.e., corresponding to the send icon 1544), whether to change a storage location of a plurality of photos (i.e., corresponding to the save icon 1546), whether to delete a plurality of photos (i.e., corresponding to the delete icon 1548), and the like.

In doing so, when a plurality of photos belonging to one group are saved, the controller 180 can save a plurality of the photos belonging to one group by merging them into a single photo.

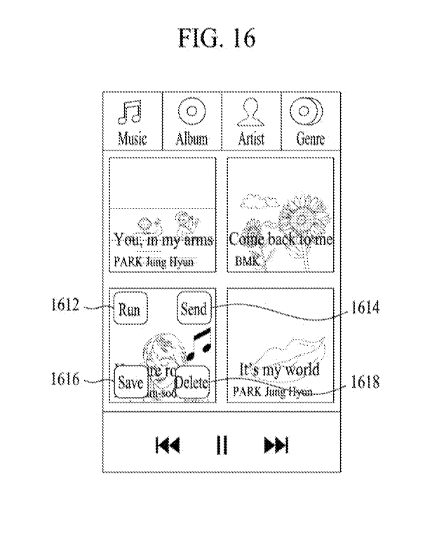

Music files can be sorted by the same album, the same genre or the same singer in accordance with a meta information tagged to each file. Hence, the controller 180 can control menu icons to be displayed by targeting a plurality of music files for a specific album, a specific genre and a specific singer. This is described in detail with reference to FIG. 16 as follows.

FIG. 16 is a diagram for one example of displaying a menu icon by targeting a plurality of music files belonging to a single group. According to the example shown in FIG. 16, music files are displayed by being sorted by album unit. In doing so, if a user input for selecting a specific album is received, like the example shown in FIG. 16, the controller 180 controls menu icons 1612, 1614, 1616 and 1618, which are provided to process a music file belonging to the selected album, to be displayed. Using the menu icons 1612, 1614, 1616 and 1618, a user is able to determine whether to play the music file belonging to the selected album (i.e., corresponding to the run icon 1612), whether to send the music file belonging to the selected album to a specific counterpart (i.e., corresponding to the send icon 1614), whether to change a storage location of the music file belonging to the selected album (i.e., corresponding to the save icon 1616), whether to delete the music file belonging to the selected album (i.e., corresponding to the delete icon 1618), and the like.

Contents mentioned in the description of the present invention may be attached to an email or message. When the email or message is displayed, the controller 180 can control menu icons, which are provided to process the contents attached to the email or message, to be displayed.

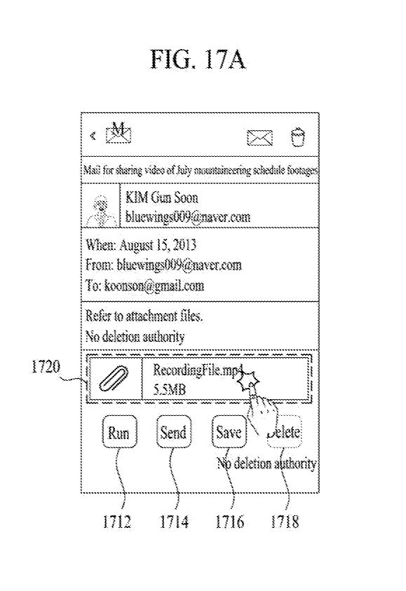

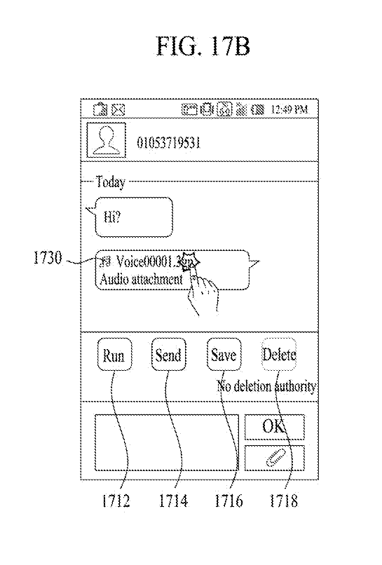

For instance, FIGS. 17A and 17B are diagrams for one example of displaying a menu icon for processing a content attached to an email or message. FIG. 17A is a diagram for one example that an attachment file exists in an email. FIG. 17B is a diagram for one example that an attachment file exists in a message (e.g., MMS).

Referring to FIG. 17A, while a file attached email is displayed, if a user input for selecting an attachment file 1720 is received, the controller 180 can control menu icons 1712, 1714, 1716 and 1718, which are provided to process the attachment file 1720), to be displayed. Using the menu icons 1712, 1714, 1716 and 1718, a user is able to determine whether to run the file attached to the email (i.e., corresponding to the run icon 1712), whether to send the attached file to a specific counterpart (i.e., corresponding to the send icon 1714), whether to save the attached file (i.e., corresponding to the save icon 1716), and the like. According to the example shown in FIG. 17A, the delete icon 1718 is displayed in a deactivated state.

Referring to FIG. 17B, while a file attached message is displayed, if a user input for selecting an attachment file 1730 is received, the controller 180 can control menu icons 1712, 1714, 1716 and 1718, which are provided to process the attachment file 1730), to be displayed. Using the menu icons 1712, 1714, 1716 and 1718, a user is able to determine whether to run the file attached to the message (i.e., corresponding to the run icon 1712), whether to send the attached file to a specific counterpart (i.e., corresponding to the send icon 1714), whether to save the attached file (i.e., corresponding to the save icon 1716), and the like. According to the example shown in FIG. 17B, the delete icon 1718 is displayed in a deactivated state.

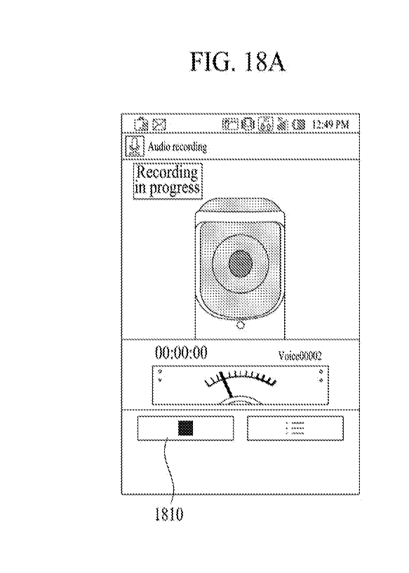

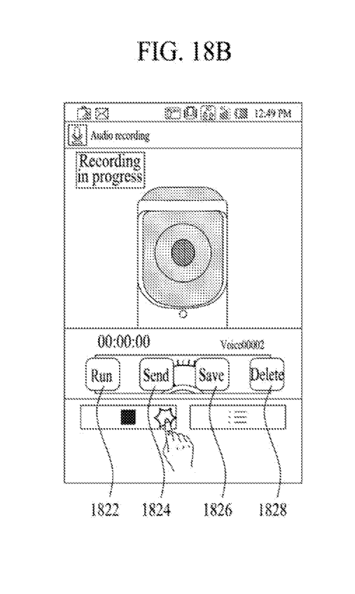

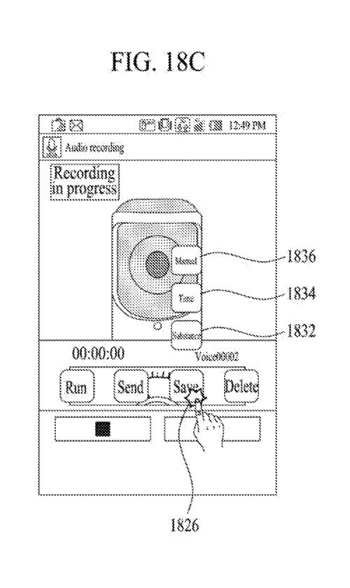

The controller 180 can control menu icons to be displayed for an incomplete content. For instance, while an audio or video is recorded, if a user's appropriate touch input is received, the controller 180 can control menu icons, which are provided to process a currently recorded audio or video file, to be displayed. This is described in detail with reference to FIGS. 18A to 18C as follows.

FIGS. 18A to 18C are diagrams for one example of displaying a menu icon for an incomplete content. For clarity of the following description, assume that the mobile terminal 100 is recording an audio signal inputted through the microphone 122. While an audio is recorded, like the example shown in FIG. 18A, the controller 180 can control a stop button 1810, which is provided to stop the recording, to be displayed. In doing so, if a user input of touching the stop button 1810 is applied, like the example shown in FIG. 18B, the controller 180 can control menu icons, which are provided to process a currently recorded audio file, to be displayed. Using the menu icons 1822, 1824, 1826 and 1828, a user is able to determine whether to stop a recording in a message and play a created audio file (i.e., corresponding to the run icon 1822), whether to stop the recording and send an audio file to a specific counterpart (i.e., corresponding to the send icon 1824), whether to stop the recording and save an audio file (i.e., corresponding to the save icon 1826), and whether to delete an amount recorded up to now (i.e., corresponding to the delete icon 1828).

In order to save an incomplete content, an appropriate file name should be given to the incomplete content. Hence, if the save icon 1826 is selected, the controller 180 can control submenus belonging to the save icon 1826 to be displayed. For instance, referring to FIG. 18C, a ‘substance’ icon 1832 is provided to have a most frequently used word included in a file name of an audio file as a result of analysis of the audio file. A ‘time’ icon 1834 may be provided to determine an audio file name based one of a created date and hour of the audio file. And, a ‘manual’ icon 1836 may be provided to guide a user to manually input a file name of an audio file.

According to the example shown in FIG. 4, a suggestion information and a content processing information are displayed at a location where a menu icon was displayed. Yet, it is not mandatory for a suggestion information and a content processing information to be displayed at a location where a menu icon was displayed. For instance, the suggestion information may be displayed at a location where an object was displayed. And, the content processing information may be displayed at a location where a submenu selected by a user was displayed. Moreover, the suggestion information and the content processing information can be outputted to the display unit 151 irrespective of locations of menu icons and submenus.

Accordingly, embodiments of the present invention provide various effects and/or features.

First of all, the present invention provides a mobile terminal and controlling method thereof, by which user's convenience can be enhanced.

In particular, the present invention provides a mobile terminal and controlling method thereof, by which a user can be guided to an application to run.

It will be appreciated by those skilled in the art that the present invention can be specified into other form(s) without departing from the spirit or scope of the inventions.

In addition, the above-described methods can be implemented in a program recorded medium as processor-readable codes. The processor-readable media may include all kinds of recording devices in which data readable by a processor are stored. The processor-readable media may include ROM, RAM, CD-ROM, magnetic tapes, floppy discs, optical data storage devices, and the like for example and also include carrier-wave type implementations (e.g., transmission via Internet).

It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mobile terminal comprising:
a display; and
a controller configured to cause the display to display:
an object related to content;
a menu icon for processing the content in response to a first touch input applied to the object;
a submenu associated with the menu icon in response to a second touch input applied to the menu icon; and
first information corresponding to the submenu at a location where the object or the menu icon was displayed in response to a third touch input applied to the submenu.

2. The mobile terminal of claim 1, wherein:
the submenu indicates an application capable of processing the content; and
the first information comprises information related to the application.

3. The mobile terminal of claim 2, wherein the information related to the application comprises at least a name of the application or an icon representing the application.

4. The mobile terminal of claim 1, wherein:
the submenu indicates a communication application for transmitting the content to another device; and
the first information comprises information related to the communication application.

5. The mobile terminal of claim 4, wherein the information related to the communication application comprises at least a name of the communication application or an icon representing the communication application.

6. The mobile terminal of claim 4, wherein the controller is further configured to cause the display to display a list of contacts while the first information is displayed at the location where the menu icon was displayed such that a contact is selectable from the list in order to transmit the content to another device corresponding to the selected contact via the communication application.

7. The mobile terminal of claim 6, wherein the controller is further configured to cause the display to include information identifying the selected contact in the first information.

8. The mobile terminal of claim 1, wherein:
the submenu indicates a storage location for saving the content; and
the first information comprises information related to the storage location.

9. The mobile terminal of claim 8, wherein the information related to the storage location comprises at least a name of the storage location or an icon representing the storage location.

10. The mobile terminal of claim 8, wherein the storage location indicated by the submenu comprises a storage location in which similar contents having same meta information as the content is stored.

11. The mobile terminal of claim 10, wherein the similar contents comprise at least one selected from the group consisting of a photo including a same subject as the content, a photo taken at a same place as the content, and a photo taken on a same date as the content.

12. The mobile terminal of claim 1, wherein, in response to release of the third touch input from the submenu, the controller is further configured to:
perform a function corresponding to the submenu; and
cause the display to display second information at the location where the menu icon was displayed or at a location where the submenu was displayed,
wherein a pointer associated with the third touch input is no longer in contact with the submenu when the third touch input is released from the submenu.

13. The mobile terminal of claim 12, further comprising a wireless communication unit configured to perform wireless communication, wherein:
the submenu indicates a communication application for transmitting the content to another device;
the controller is further configured to cause the wireless communication unit to transmit the content to another device via the communication application; and
the second information comprises at least status information indicating a status of the transmission of the content or progress information indicating a progress level of the transmission of the content.

14. The mobile terminal of claim 12, further comprising a memory configured to store the content, wherein:
the submenu indicates a storage location for saving the content;
the controller is further configured to cause storing of the content in the storage location; and
the second information comprises at least status information indicating a status of the storing of the content or progress information indicating a progress level of the storing of the content.

15. The mobile terminal of claim 1, wherein at least the second touch input or the third touch input comprises dragging to the menu icon or the submenu.

16. A mobile terminal comprising:
a display; and
a controller configured to cause the display to display:
an object related to content;
at least one menu icon for processing the content in response to a first touch input applied to the object; and
first information suggesting a scheme for processing the content at a location where the object or one of the at least one menu icon was displayed in response to a second touch input applied to the one of the at least one menu icon.

17. The mobile terminal of claim 16, wherein the suggested scheme is an application that is used most recently or most frequently to process contents of a same type as the content related to the object.

18. The mobile terminal of claim 16, wherein:
the suggested scheme is a first communication application for communicating with another device;
the first information comprises contact information corresponding to another device; and
another device is a device that communicated with the mobile terminal most recently or most frequently.

19. The mobile terminal of claim 18, wherein the controller is further configured to cause the display to:
display a submenu associated with a second communication application;
change the suggested scheme from the first communication application to the second communication application in response to a third touch input applied to the submenu; and
display the second communication application as the suggested scheme at the location where the one of the at least one menu icon was displayed,
wherein the third touch input is applied while the first information, which is displayed at the location where the one of the at least one menu icon was displayed, indicates the first communication application as the suggested scheme.

20. A method of controlling a mobile terminal, comprising:
displaying an object related to content;
displaying a menu icon for processing the content in response to a first touch input applied to the object;
displaying a submenu associated with the menu icon in response to a second touch input applied to the menu icon; and
displaying information corresponding to the submenu at a location where the object or the menu icon was displayed in response to a third touch input applied to the submenu.
